(19) United States
(12) Patent Application Publication
(10) Pub. No.: US 2026/0046772 A1
(43) Pub. Date: Feb. 12, 2026

(54) SIGNALING FOR CONFIGURABLE AIR INTERFACE

(71) Applicant: Samsung Electronics Co., Ltd., Suwon-si (KR)

(72) Inventors: Emad Nader Farag, Flanders, NJ (US); Aristides Papasakellariou, Houston, TX (US)

(21) Appl. No.: 19/275,821

(22) Filed: Jul. 21, 2025

Related U.S. Application Data
(60) Provisional application No. 63/682,152, filed on Aug. 12, 2024.
(60) Provisional application No. 63/721,115, filed on Nov. 15, 2024.
(60) Provisional application No. 63/748,344, filed on Jan. 22, 2025.

(51) Int. Cl. H04W 52/02

(52) U.S. Cl. CPC H04W 52/0235

(57) ABSTRACT

Methods and apparatuses for code block group signaling. A method of operating a user equipment (UE) includes receiving a first wake-up signal (WUS), receiving first configuration information in a first channel associated with the first WUS, after a time T1 from the first WUS, and applying the first configuration information after a time T2 from reception of the first channel.

### CROSS-REFERENCE TO RELATED AND CLAIM OF PRIORITY

The present application claims priority under 35 U.S.C. § 119(e) to U.S. Provisional Patent Application No. 63/682,152 filed on Aug. 12, 2024, U.S. Provisional Patent Application No. 63/721,115 filed on Nov. 15, 2024, and U.S. Provisional Patent Application No. 63/748,344 filed on Jan. 22, 2025 which are hereby incorporated by reference in their entirety.

### TECHNICAL FIELD

The present disclosure relates generally to wireless communication systems and, more specifically, the present disclosure relates to methods and apparatuses for configurable air interface and code block group (CBG) signaling.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to configurable air interface and CBG signaling.

In one embodiment, a user equipment (UE) is provided. The UE includes a transceiver configured to receive a first wake-up signal (WUS) and receive first configuration information in a first channel associated with the first WUS, after a time T1 from the first WUS. The UE further includes a processor operably coupled to the transceiver. The processor is configured to apply the first configuration information after a time T2 from reception of the first channel.

In another embodiment, a base station (BS) is provided. The BS includes a transceiver configured to transmit a first WUS and transmit first configuration information in a first channel associated with the first WUS, after a time T1 from the first WUS. The BS further includes a processor operably coupled to the transceiver. The processor is configured to apply the first configuration information after a time T2 from reception of the first channel.

In yet another embodiment, a method of operating a UE is provided. The method includes receiving a first WUS, receiving first configuration information in a first channel associated with the first WUS, after a time T1 from the first WUS, and applying the first configuration information after a time T2 from reception of the first channel.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates an example of multiple slots/carriers according to embodiments of the present disclosure;

FIG. 8 illustrates an example synchronization signal/physical broadcast channel (SS/PBCH) block according to embodiments of the present disclosure;

FIGS. 9A and 9B illustrate an example uplink (UL) downlink (DL) configuration according to embodiments of the present disclosure;

FIG. 10 illustrates an example UL DL configuration according to embodiments of the present disclosure;

FIG. 11 illustrates an example discontinuous reception (DRX) according to embodiments of the present disclosure;

FIGS. 12A, 12B, 12C, 12D, and 12E illustrate an example resource configuration according to embodiments of the present disclosure;

FIGS. 13A, 13B, 13C, 13D, 13E, 13F, and 13G illustrate example of signaling configuration information according to embodiments of the present disclosure;

FIG. 14 illustrates an example of signaling and application timing of configuration information according to embodiments of the present disclosure;

FIG. 15 illustrates an example of gNB triggering and application of configuration information according to embodiments of the present disclosure;

FIG. 16 illustrates an example of UE triggering and application of configuration information according to embodiments of the present disclosure;

FIG. 17 illustrates a timeline of example full duplex configurations according to embodiments of the present disclosure;

FIGS. 18A and 18B illustrate an example numerology configuration according to embodiments of the present disclosure; and

FIG. 19 illustrates an example method 1900 performed by a UE in a wireless communication system according to embodiments of the present disclosure.

### DETAILED DESCRIPTION

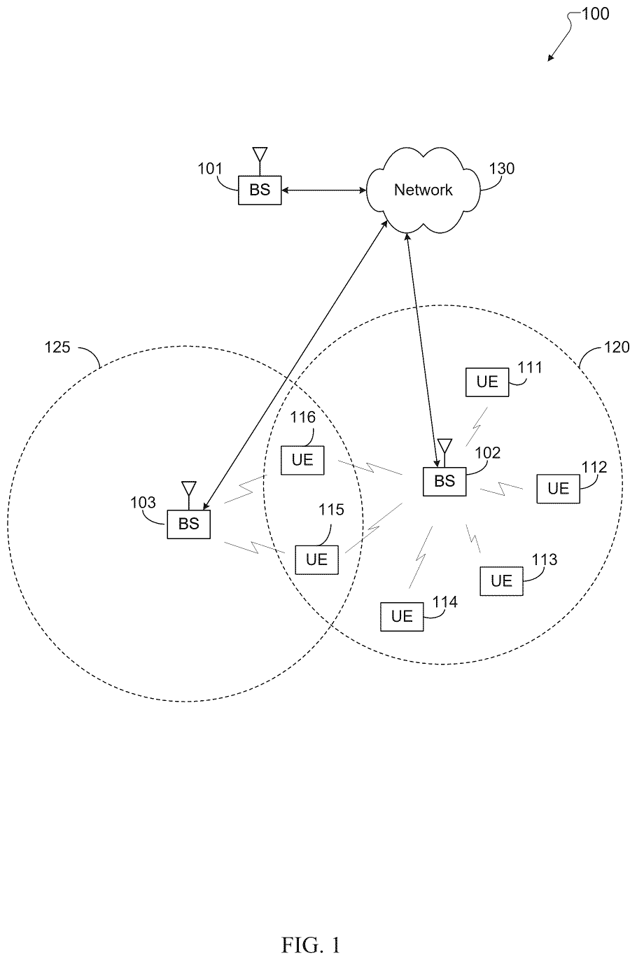

FIGS. 1-19, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 38.211 v18.3.0-v18.4.0, “NR; Physical channels and modulation;” [REF 2] 3GPP TS 38.212 v18.3.0-v18.4.0, “NR; Multiplexing and Channel coding;” [REF 3] 3GPP TS 38.213 v18.3.0-v18.4.0, “NR; Physical Layer Procedures for Control;” [REF 4] 3GPP TS 38.214 v18.3.0-v18.4.0, “NR; Physical Layer Procedures for Data;” [REF 5] 3GPP TS 38.321 v18.2.0-v18.3.0, “NR; Medium Access Control (MAC) protocol specification;” and [REF 6] 3GPP TS 38.331 v18.2.0-v18.3.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UTE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof to identify configurable air interface signaling and receiving/transmitting CBG signaling. In certain embodiments, one or more of the BSs 101-103 include circuitry, programing, or a combination thereof for configurable air interface signaling and transmitting/receiving CBG signaling.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

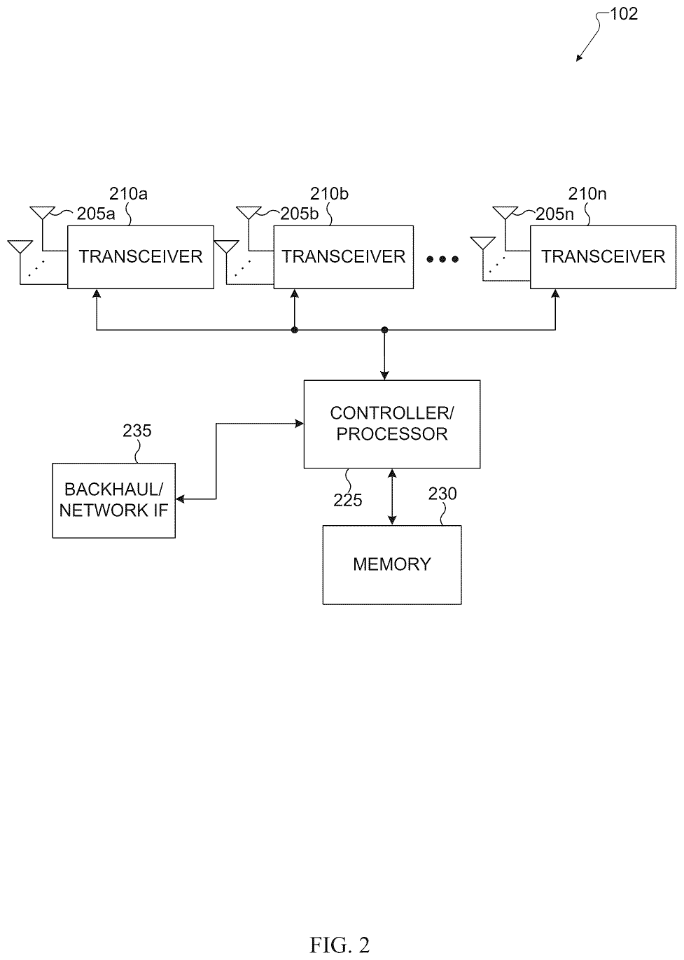

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as performing configurable air interface signaling and CBG signaling. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

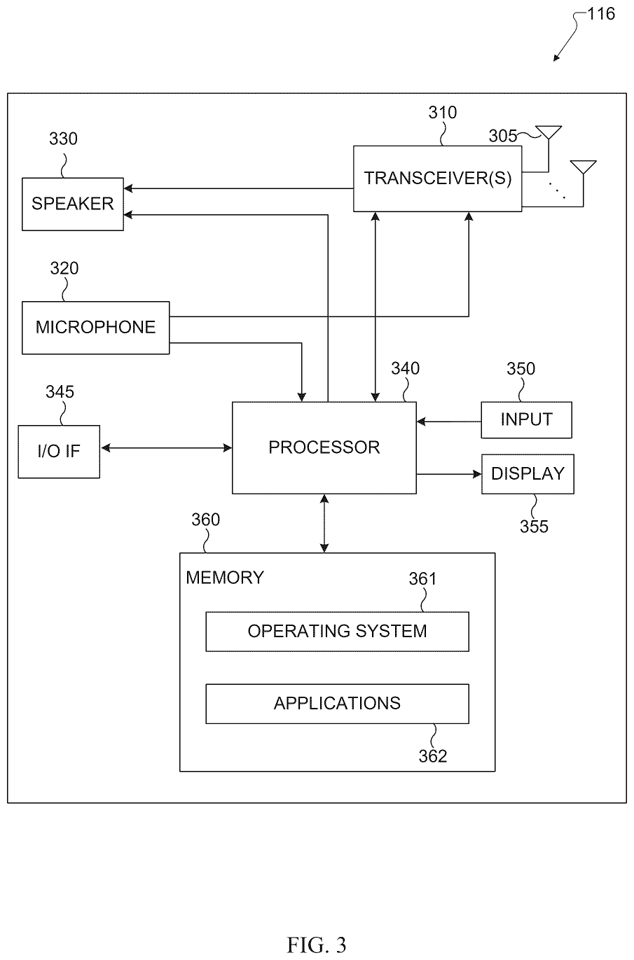

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the ULE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to identify configurable air interface signaling and CBG signaling as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

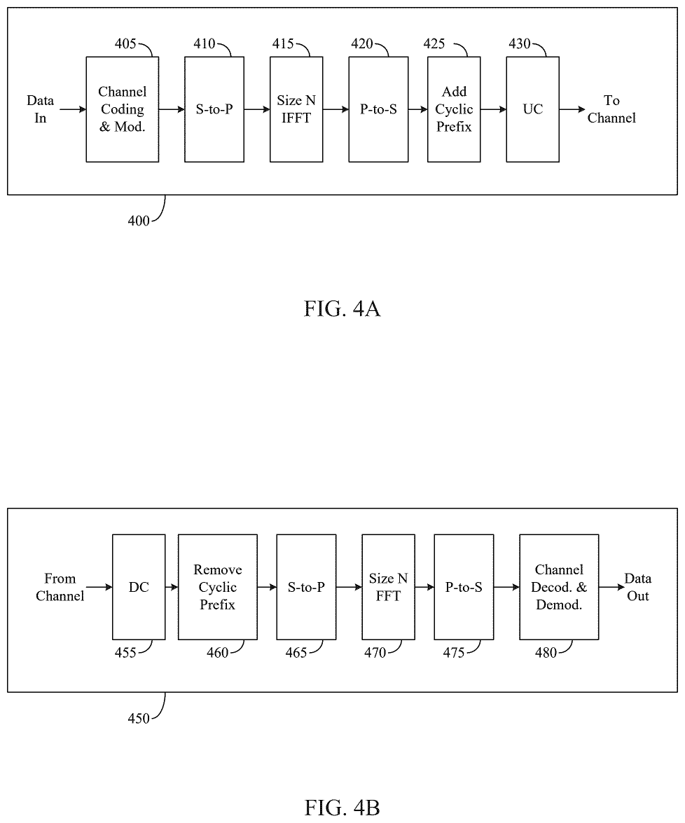

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured to support configurable air interface and CBG signaling as described in embodiments of the present disclosure. In some embodiments, the receive path 450 is configured to support configurable air interface and CBG signaling as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

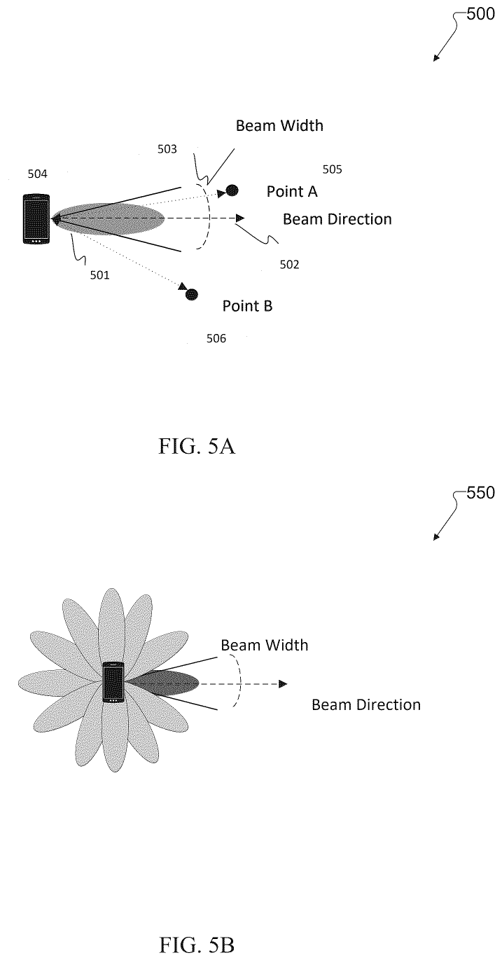

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

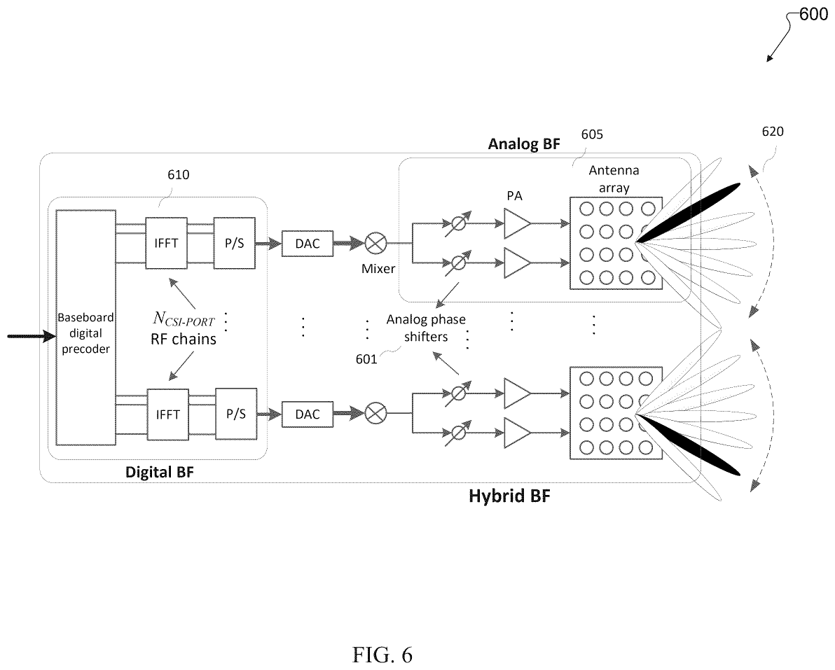

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state indication refence signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

A time unit for DL signaling, for UL signaling, or for sidelink (SL) signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. As another example, a slot can have a duration of 0.25 milliseconds and include 14 symbols and an RB can have a BW of 720 kHz and include 12 SCs with SC spacing of 60 kHz. An RB in one symbol of a slot is referred to as physical RB (PRB) and includes a number of resource elements (REs). A slot can be either full DL slot, or full UL slot, or hybrid slot similar to a special subframe in time division duplex (TDD) systems (see also REF 1). In addition, a slot can have symbols for SL communications. A UE can be configured one or more bandwidth parts (BWPs) of a system BW for transmissions or receptions of signals or channels.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format. A DCI format scheduling PDSCH reception or PUSCH transmission for a single UE, such as a DCI format with cyclic redundancy check (CRC) scrambled by cell-radio network temporary identifier (C-RNTI)/configured scheduling RNTI (CS-RNTI)/modulation and coding scheme (MCS)-C-RNTI as described in [REF 2], are referred for brevity as a unicast DCI format. A DCI format scheduling PDSCH reception for multicast communication, such as a DCI format with CRC scrambled by group RNTI (G-RNTI)/G-CS-RNTI as described in [REF 2], are referred to as multicast DCI format. DCI formats providing various control information to at least a subset of UEs in a serving cell, such as DCI format 2_0 in [REF 2], are referred to as group-common (GC) DCI formats.

A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB (such as BS 102) transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI includes NZP CSI-RS and CSI-IM resources. A UE (such as UE 116) can determine CSI-RS transmission parameters through DL control signaling or higher layer signaling, such as radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, link recovery request (LRR) for beam failure recovery, CSI reports enabling a gNB to select appropriate parameters for PDSCH or PDCCH transmissions to a UE, and UE initiated resource indicator (UEI-RI) indicating a request to transmit a UE initiated measurement report. HARQ-ACK information can be configured to be with a smaller granularity than per TB and can be per data code block (CB) or per group of data CBs where a data TB includes a number of data.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH).

An antenna port is defined such that the channel over which a symbol on the antenna port is conveyed can be inferred from the channel over which another symbol on the same antenna port is conveyed.

For demodulation reference signal (DM-RS) associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may expect the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may expect that synchronization signal (SS)/PBCH block (also denoted as synchronization signal blocks (SSBs)) transmitted with the same block index on the same center frequency location are quasi co-located with respect to Doppler spread, Doppler shift, average gain, average delay, delay spread, and, when applicable, spatial Rx parameters. The UE may not expect quasi co-location for any other synchronization signal SS/PBCH block transmissions.

In absence of CSI-RS configuration, and unless otherwise configured, the UE may expect PDSCH DM-RS and SSB to be quasi co-located with respect to Doppler shift, Doppler spread, average delay, delay spread, and, when applicable, spatial Rx parameters. The UE may expect that the PDSCH DM-RS within the same code division multiplexing (CDM) group is quasi co-located with respect to Doppler shift, Doppler spread, average delay, delay spread, and spatial Rx. The UE may also expect that DM-RS ports associated with a PDSCH are QCL with QCL type A, type D (when applicable) and average gain. The UE may further expect that no DM-RS collides with the SS/PBCH block.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

The quasi-co-location relationship is configured by the higher layer parameter qcl-Type1 for the first DL RS, and qcl-Type2 for the second DL RS (if configured). For the case of two DL RSs, the QCL types may not be the same, regardless of whether the references are to the same DL RS or different DL RSs. The quasi-co-location types corresponding to each DL RS are given by the higher layer parameter qcl-Type in QCL-Info and may take one of the following values: QCL-TypeA: {Doppler shift, Doppler spread, average delay, delay spread}; QCL-TypeB: {Doppler shift, Doppler spread}; QCL-TypeC: {Doppler shift, average delay}; and QCL-TypeD: {Spatial Rx parameter}.

The UE receives a MAC-CE activation command to map up to [N] (e.g., N=8) TCI states to the codepoints of the DCI field “Transmission Configuration Indication.” When the HARQ-ACK corresponding to the PDSCH carrying the activation command is transmitted in slot n, the indicated mapping between TCI states and codepoints of the DCI field “Transmission Configuration Indication” may be applied after a MAC-CE application time, e.g., starting from the first slot that is after slot

$$( n + 3 {N}_{slot}^{subframe , μ} ) .$$

In this disclosure, a beam can be determined by any of,
A TCI state, that establishes a quasi-colocation (QCL) relationship or spatial relation between a source reference signal (e.g. SSB and/or CSI-RS) and a target reference signal
A spatial relation information that establishes an association to a source reference signal, such as SSB or CSI-RS or SRS.

In either case, the ID of the source reference signal or TCI state or spatial relation identifies the beam.

The TCI state and/or the spatial relation reference RS can determine a spatial Rx filter for reception of downlink channels at the UE, or a spatial Tx filter for transmission of uplink channels from the UE. The TCI state and/or the spatial relation reference RS can determine a spatial Tx filter for transmission of downlink channels from the gNB, or a spatial Rx filter for reception of uplink channels at the gNB.

NR Rel-15 introduced CBG-based PDSCH transmission and HARQ-ACK feedback, if a UE is configured to receive CBG based transmissions by receiving the higher layer parameter PDSCH-CodeBlockGroupTransmission for PDSCH, the UE shall determine the number of CBGs for a transport block reception as M=min(N, C). Wherein;
N is the maximum number of CBGs per transport block as configured by maxCodeBlockGroupsPerTransportBlock for PDSCH. N=2, 4, 6, or 8.
C is the number of code blocks in the transport block.
Define,

$${M}_{1} = mod ( C , M ) , {K}_{1} = ⌈ \frac{C}{M} ⌉ and {K}_{2} = ⌊ \frac{C}{M} ⌋ .$$

If M₁>0, CBG m, m=0, 1, . . . , M₁−1 includes code blocks with indices m K₁+k, where, k=0, 1, . . . , K₁−1.
CBG m, m=M₁, 1, . . . , M−1 includes code blocks with indices M₁ K₁+(m−M₁)·K₂+k, where, k=0, 1, . . . , K₂−1.

If a UE is provided PDSCH-CodeBlockGroupTransmission for a serving cell, the UE receives a PDSCH scheduled by DCI format 1_1, that includes CBGs of a transport block. The UE determines a number of HARQ-ACK bits for the transport block as M.

The HARQ-ACK codebook includes M^{max} bits, where M^{max} is provided by maxCodeBlockGroupsPerTransportBlock. The HARQ-ACK information bits are arranged in ascending order of CBG index, if M<M^{max}, for a transport block, the UE generates a negative ACK (NACK) value for the last M^{max}−M HARQ-ACK information bits for the transport block in the HARQ-ACK codebook.

The UE generates an ACK for the HARQ-ACK information bit of a CBG if the UE correctly received code blocks of the CBG and generates a NACK for the HARQ-ACK information bit of a CBG if the UE incorrectly received at least one code block of the CBG. If the UE receives two transport blocks, the UE concatenates the HARQ-ACK information bits for CBGs of the second transport block after the HARQ-ACK information bits for CBGs of the first transport block.

If the UE generates a HARQ-ACK codebook in response to a retransmission of a transport block, corresponding to a same HARQ process as a previous transmission of the transport block, the UE generates an ACK for each CBG that the UE correctly decoded in a previous transmission of the transport block.

If a UE correctly detects each of the M CBGs and does not correctly detect the transport block for the M CBGs, the UE generates a NACK value for each of the M CBGs.

If a UE is configured to receive CBG-based transmissions by receiving the higher layer parameter PDSCH-CodeBlockGroupTransmission for PDSCH:
The ‘CBG transmission information’ (CBGTI) field of DCI format 1_1 is of length N_{TB}·N bits, where N_{TB} is the value of the higher layer parameter maxNrofCodeWordsScheduledByDCI. If N_{TB}=2 the CBGTI field bits are mapped such that the first set of N bits starting from the most significant bit (MSB) corresponds to the first TB while the second set of N bits corresponds to a second TB, if scheduled. The first M bits of each set of N bits in the CBGTI field have an in-order one-to-one mapping with the M CBGs of the TB, with the MSB mapped to CBG #0.
For initial transmission of a TB as indicated by the ‘New Data Indicator’ field of the scheduling DCI, the UE may expect that the CBGs of the TB are present.
For a retransmission of a TB as indicated by the ‘New Data Indicator’ field of the scheduling DCI, the UE may expect that
   The ‘CBGTI’ field of the scheduling DCI indicates which CBGs of the TB are present in the transmission. A bit value of ‘0’ in the CBGTI field indicates that the corresponding CBG is not transmitted and ‘1’ indicates that it is transmitted.
   If the ‘CBG flushing out information’ (CBGFI) field of the scheduling DCI is present, ‘CBGFI’ set to ‘0’ indicates that the earlier received instances of the same CBGs being transmitted may be corrupted, and ‘CBGFI’ set to ‘1’ indicates that the CBGs being retransmitted are combinable with the earlier received instances of the same CBGs.
   A CBG contains the same CBs as in the initial transmission of the TB.

DCI format 1_1 is used for the scheduling of one or multiple PDSCH in one cell. DCI Format 1_1 can include the following fields:
CBG transmission information (CBGTI). CBGTI is 0 bits if higher layer parameter PDSCH-CodeBlockGroupTransmission for PDSCH is not configured, otherwise CBGTI is 2, 4, 6, or 8 bits CBGTI can be determined as the product of maxCodeBlockGroupsPerTransportBlock and maxNrofCodeWordsScheduledByDCI. If higher layer parameter priorityIndicatorDCI-1-1 is configured, if the bit width of the CBG transmission information in DCI format 1_1 for one HARQ-ACK codebook is not equal to that of the CBG transmission information in DCI format 1_1 for the other HARQ-ACK codebook, a number of most significant bits with value set to ‘0’ are inserted to smaller CBG transmission information until the bit width of the CBG transmission information in DCI format 1_1 for the two HARQ-ACK codebooks are the same
CBG flushing out information (CBGFI). CBGFI is 1 bit if higher layer parameter codeBlockGroupFlushIndicator is configured as “TRUE”, otherwise CBGFI is 0 bit. If higher layer parameter priorityIndicatorDCI-1-1 is configured, if the bit width of the CBG flushing out information in DCI format 1_1 for one HARQ-ACK codebook is not equal to that of the CBG flushing out information in DCI format 1_1 for the other HARQ-ACK codebook, a number of most significant bits with value set to ‘0’ are inserted to smaller CBG flushing out information until the bit width of the CBG flushing out information in DCI format 1_1 for the two HARQ-ACK codebooks are the same.

NR Rel-15 introduced CBG-based PUSCH transmission, if a UE is configured to transmit CBG based transmissions by receiving the higher layer parameter codeBlockGroupTransmission in PUSCH-ServingCellConfig, the UE shall determine the number of CBGs for a transport block transmission as M=min(N, C). Wherein
N is the maximum number of CBGs per transport block as configured by maxCodeBlockGroupsPerTransportBlock in PUSCH-ServingCellConfig,
C is the number of code blocks in the transport block.
Define,

$${M}_{1} = mod ( C , M ) , {K}_{1} = ⌈ \frac{C}{M} ⌉ and {K}_{2} = ⌊ \frac{C}{M} ⌋ .$$

If M₁>0, CBG m, m=0, 1, . . . , M₁−1 includes code blocks with indices m K₁+k, where, k=0, 1, . . . , K₁−1.
CBG m, m=M₁, 1, . . . , M−1 includes code blocks with indices M₁ K₁+(m−M₁)·K₂+k, where, k=0, 1, . . . , K₂−1.

If a UE is configured to transmit CBG-based transmissions by receiving the higher layer parameter codeBlockGroupTransmission in PUSCH-ServingCellConfig,
For an initial transmission of a TB as indicated by the ‘New Data Indicator’ field of the scheduling DCI, the UE may expect that the CBGTI field indicates the CBGs of the TB are to be transmitted, and the UE shall include the CBGs of the TB.
For a retransmission of a TB as indicated by the ‘New Data Indicator’ field of the scheduling DCI, the ULE (e.g., the UE 116) shall include only the CBGs indicated by the CBGTI field of the scheduling DCI.
A bit value of ‘0’ in the CBGTI field indicates that the corresponding CBG is not to be transmitted and ‘1’ indicates that it is to be transmitted. The order of CBGTI field bits is such that the CBGs are mapped in order from CBG #0 onwards starting from the MSB.

DCI format 0_1 is used for the scheduling of one or multiple PUSCH in one cell. DCI Format 0_1 can include the following field:
CBG transmission information (CBGTI). CBGTI is 0 bits if higher layer parameter codeBlockGroupTransmission for PUSCH is not configured or if the number of scheduled PUSCH indicated by the Time domain resource assignment field is larger than 1; otherwise CBGTI is 2, 4, 6, or 8 bits and is determined by higher layer parameter maxCodeBlockGroupsPerTransportBlock and maxRank or maxMIMO-Layers for PUSCH.

A transport block for PDSCH or PUSCH including M CBGs has a low target block error rate (e.g., 10%, 1% or even lower in some applications). The error rate of a CBG of the M CBGs is even lower. Hence, the probability of having multiple (e.g., two or more) CBGs in error would be quite low. Allowing signaling for CBGs patterns, e.g., for M CBGs, there are 2^{M} CBG patterns is not efficient as some patterns have a very low probability of occurrence as described in this disclosure. Hence, embodiments of the present disclosure recognize that CBG signaling is needed and can be designed or configured with code points for high probability occurring CBG error patterns, other patterns (e.g., with lower probability) can be signaled by a single code point. Signaling for CBG can include HARQ-ACK feedback signaling, as well as CBG indicating in DCI Formats (e.g., CBGTI and CBGFI). In this disclosure, design aspects are provided for reducing the CBG overhead.

CBG-based operation for PDSCH and PUSCH can reduce overhead when the transport block size is large by only retransmitting the CBGs in error. A downside of CBG-based operation is the increase in signaling overhead. This disclosure addresses the signaling overhead by indicating patterns that are likely to occur, and having a default indication for the other patterns which can correspond to full retransmission.

As described herein, a transport block can include multiple (e.g., M) CBGs. The target error rate of a transport block (e.g., block error rate (BLER)) is typical low, e.g., 10%, 1% or even lower for some applications. Let e be the target error rate of a transport block. If the transport block is made up of M CBGs and the CBGs' error are independent and identically distributed, with a CBG error rate of e_{c}. Therefore, the probability of getting a successfully decoded transport block in terms of the CBG error rate e_{c} is:

$$1 - e = {( 1 - {e}_{c} )}^{M}$$

### Therefore,

$${e}_{c} = 1 - {( 1 - e )}^{1 / M}$$

Table 1 shows examples of e_{c} for different values of M and BLER e. The probability that two or more CBGs are in error can be given by: 1—probability that there is no CBG errors (which equals 1−e)—probability that one CBG is in error (which equals

$$M {{e}_{c} ( 1 - {e}_{c} )}^{M - 1} = M ( 1 - e ) \frac{{e}_{c}}{1 - {e}_{c}}$$

Therefore, probability of two or more CBGs are in

$$error = e - M ( 1 - e ) \frac{{e}_{c}}{1 - {e}_{c}} .$$

This is illustrated in Table 1.

The probability that three or more CBGs are in error can be given by: 1—probability that there is no CBG errors (which equals 1−e)—probability that one CBG is in error (which equals

$$M {{e}_{c} ( 1 - {e}_{c} )}^{M - 1} = M ( 1 - e ) \frac{{e}_{c}}{1 - {e}_{c}} )$$

probability that two CBGs are in error (which equals

$$\frac{M ( M - 1 )}{2} {{e}_{c}^{2} ( 1 - {e}_{c} )}^{M - 2} = \frac{M ( M - 1 )}{2} ( 1 - e ) \frac{{e}_{c}^{2}}{{( 1 - {e}_{c} )}^{2}} ) .$$

Therefore, probability of three or more CBGs are in

$$error = e - M ( 1 - e ) \frac{{e}_{c}}{1 - {e}_{c}} - \frac{M ( M - 1 )}{2} ( 1 - e ) \frac{{e}_{c}^{2}}{{( 1 - {e}_{c} )}^{2}} .$$

This is illustrated in Table 1.

TABLE 1

| e | M | e_{c} | 2 or more CBGS in error | 3 or more CBGS in error |
|---|---|---|---|---|
| 0.1 | 4 | 2.6e−2 | 3.92e−3 | 6.89e−05 |
| 0.1 | 6 | 1.74e−2 | 4.34e−3 | 1.01e−04 |
| 0.1 | 8 | 1.31e−2 | 4.55e−3 | 1.19e−04 |
| 0.1 | 12 | 8.74e−3 | 4.76e−3 | 1.39e−04 |
| 0.1 | 14 | 7.5e−3 | 4.82e−3 | 1.44e−04 |
| 0.1 | 16 | 6.56e−3 | 4.86e−3 | 1.49e−04 |
| 0.01 | 4 | 2.51e−3 | 3.77e−5 | 6.31e−08 |
| 0.01 | 6 | 1.67e−3 | 4.18e−5 | 9.34e−08 |
| 0.01 | 8 | 1.26e−3 | 4.39e−5 | 1.10e−07 |
| 0.01 | 12 | 8.37e−4 | 4.6e−5 | 1.28e−07 |
| 0.01 | 14 | 7.18e−4 | 4.66e−5 | 1.34e−07 |
| 0.01 | 16 | 6.28e−4 | 4.7e−5 | 1.38e−07 |

As illustrated in Table 1, the probability that 2 or more CBGs are in error is small, and the probability that 3 or more CBGs are in error is even much smaller. Therefore, it would seem reasonable to limit the number of code points used to signal the CBGTI or for HARQ-ACK feedback to the events with the highest probability. Events with a lower probability can be group together in a single code point (e.g., default code point).

To illustrate this, by way of example, let's take M=6, the CBG HARQ-ACK feedback and CBGTI can be designed to signal the following code points:
Code point 0: No CBG errors
Code points 1 to 6: A single CBG error in CBG index 0 to 5 respectively.
Code point 7: Retransmit CBGs (e.g., default code point for other patterns).

In this example, 3-bits can be used for CBG HARQ-ACK feedback and CBGTI. This represents a 50% savings in bit size when compared a codebook that feedbacks CBG error combinations when M=6.

In another example, let's take M=8, the CBG HARQ-ACK feedback and CBGTI can be designed to signal the following code points:
Code point 0: No CBG errors
Code points 1 to 8: A single CBG error in CBG index 0 to 5 respectively.
Code point 9 (or code point 15): Retransmit CBGs (e.g., default code point for other patterns).

In this example, 4-bits can be used for CBG HARQ-ACK feedback and CBGTI. This represents a 50% savings in bit size when compared to a codebook that feedbacks CBG error combinations when M=8. There are unused code points with the 4-bit code book, for example code points 10 to 15 (or code points 9 to 14 respectively), these can be left as reserved, or alternatively these can be used to indicate other CBG patterns, for example, consecutive pairs of CBGs that are in error (when error is bursty, consecutive CBG error patterns can be more likely).

In a another example, let's take M=14, the CBG HARQ-ACK feedback and CBGTI can be designed to signal up to two CBGs in error or CBGs are in error. The number of code points in this case is given by:
1 code point 1 indicating no CBG errors.
14 code points indicating one CBG in error and corresponding index
14×13/2 code points indicating two CBGs (a pair of CBGs) in error and corresponding CBG pair index
1 code point for other cases, e.g., for re-transmission of al CBGs (e.g., default code point for other patterns).

Hence, a total of 107 code points can be used. In this example, 7-bits can be used for CBG HARQ-ACK feedback and CBGTI. This represents 50% savings in bit size when compared a codebook that feedbacks CBG error combinations when M=14. The remaining code points (128−107=21) can be left are reserved, or alternatively these can be used to indicate other CBG patterns, e.g., CBG patterns from the remaining CBG patterns with the highest likelihood of occurrence as aforementioned.

In the last example, if the CBG HARQ-ACK feedback and CBGTI is designed to signal a single CBG error, the CBG HARQ-ACK feedback and CBGTI can be designed to signal the following code points:
Code point 0: No CBG errors
Code points 1 to 14: A single CBG error in CBG index 0 to 5 respectively.
Code point 15: Retransmit CBGs.

Hence, a total of 16 code points can be used. In this example, 4-bits can be used for CBG HARQ-ACK feedback and CBGTI. This represents over 70% savings in bit size when compared a codebook that feedbacks CBG error combinations when M=14.

In a another example, let's take M=16, the CBG HARQ-ACK feedback and CBGTI can be designed to signal up to two CBGs in error or CBGs are in error. The number of code points in this case is given by:
1 code point indicating no CBG errors.
16 code points indicating one CBG in error and corresponding index
16×15/2 code points indicating two CBGs (a pair of CBGs) in error and corresponding CBG pair index
1 code point for other cases, e.g., for re-transmission of CBGs (e.g., default code point for other patterns).

Hence, a total of 138 code points can be used. In this example, 8-bits can be used for CBG HARQ-ACK feedback and CBGTI. This represents 50% savings in bit size when compared a codebook that feedbacks CBG error combinations when M=16. The remaining code points (256−138=118) can be left are reserved, or alternatively these can be used to indicate other CBG patterns, e.g., CBG patterns from the remaining CBG patterns with the highest likelihood of occurrence as aforementioned.

In the last example, if the CBG HARQ-ACK feedback and CBGTI is designed to signal a single CBG error, the CBG HARQ-ACK feedback and CBGTI can be designed to signal the following code points:
Code point 0: No CBG errors
Code points 1 to 16: A single CBG error in CBG index 0 to 5 respectively.
Code point 17: Retransmit CBGs (e.g., default code point for other patterns).

Hence, a total of 18 code points can be used. In this example, 5-bits can be used for CBG HARQ-ACK feedback and CBGTI. This represents about 70% savings in bit size when compared a codebook that feedbacks CBG error combinations when M=16. The remaining code points (32−18=14) can be left are reserved, or alternatively these can be used to indicate other CBG patterns, e.g., CBG patterns from the remaining CBG patterns with the highest likelihood of occurrence as aforementioned.

In this disclosure, signaling framework with reduced overhead is provided. For M CBGs a subset of CBG patterns can be signaled between the network (e.g., the network 130) and gNB (e.g., the BS 102). A CBG pattern can be represented by a code point. In one example, a code point can indicate which CBGs are in error and which CBGs are not in error when used for HARQ-ACK feedback. In one example, a code point can indicate which CBG to transmit (or is transmitted) and which CBG not transmit (or is not transmitted) when signaled in DCI Format (e.g., using the CBGTI field). In one example, a code point can indicate which CBG, from an earlier transmission, to flush or to combine when signaled in DCI Format (e.g., using CBGFI field).

In a variant example, the aforementioned signaling framework for CBG can be extended to multi-carrier and/or multi-slot scheduling and/or HARQ-ACK feedback.

The present disclosure relates to a 5G/NR and/or 6G communication system.

This disclosure provides a signaling framework for CBG, the following aspects are provided:
A set of code points for CBG indication.
The association of code points to CBGs can be determined by a design rule and/or by configuration.
The CBG code points can be used for HARQ ACK field and/or for indicating in DCI (e.g., CBGTI and CBGFI).
Extension of the CBG framework to multi-carrier and/or multi-slot scheduling and/or HARQ-ACK feedback.

In the following, both frequency division duplex (FDD) and time-division duplex (TDD) are regarded as a duplex method for DL and UL signaling. In addition, full duplex (XDD) operation is possible, e.g., sub-band full duplex (SBFD) or single frequency full duplex (SFFD).

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure provides several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based signaling (e.g., SIB1 or other SIB) or (2) RRC dedicated signaling that is sent to a specific UE wherein the information can be common/cell-specific information or dedicated/UE-specific information or (3) UE-group RRC signaling.

In this disclosure MAC CE signaling can be UE-specific e.g., to one UE or can be UE common (e.g., to a group of UEs) or all UEs in a cell. MAC CE signaling can be DL MAC CE signaling or UL MAC CE signaling.

In this disclosure L1 control signaling includes: (1) DL control information (e.g., DCI on PDCCH or DL control information on PDSCH) and/or (2) UL control information (e.g., UCI on PUCCH or PUSCH). L1 control signaling can be UE-specific e.g., to one UE or can be UE common (e.g., to a group of UEs or all UEs in a cell).

In this disclosure, configuration can refer to configuration by semi-static signaling (e.g., RRC or SIB signaling). In one example, a configuration can be applicable to multiple transmission instances, until a new configuration is received and applied.

In this disclosure, indication can refer to indication by dynamic signaling (e.g., L1 control (e.g., DCI Format) or MAC CE signaling). In one example, an indication can be for an associated occasion(s) (e.g., an occasion or multiple occasions associated with the indication).

In this disclosure a list with N elements can be denoted as L(i), where i can take N values, and L(i) can correspond to the element or entry associated with index i. In one example, i can take N arbitrary values. In one example, i=0, 1, . . . , N−1. In one example, i=1, 2, . . . , N. In one example, i is an identity of an element in the list.

In the present disclosure, the term “activation” describes an operation wherein a UE receives and decodes first information provided by a first signal from the network (or gNB) and, based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or gNB) and, based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, for example, a frequency-unit can be a sub-carrier or a resource block (RB) or a sub-channel, wherein a sub-channel is a group or RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

Terminology such as code block (CB), CBG, DCI Format, uplink control information (UCI), HARQ-ACK and other terms is used for illustrative purposes and is therefore not normative. Other terms that refer to same functions can also be used.

In one example of the following example, a CBG can have one code book (e.g., each CBG is one code book).

In one example, a network can configure and a UE can receive a configuration of a CBG code book. In one example, a CBG code book can include N entries. In one example, N=2ⁿ, wherein n can be a positive integer. In one example, for an entry with index i belonging to the code book, wherein i=0, 1, . . . , N−1, or i=1, 2, . . . , N, for each CBG of the M CBGs a flag (e.g., f_{i,j}) is configured, for example, the flag can be configured, wherein j is the index of the CBG, wherein j=0, 1, . . . , M−1, or j=1, 2, . . . , M. As an example, for N=8 code book entries and M=4 CBGs, the configuration of the code book can be as illustrated in Table 2. In one example, f_{i,j} can take a binary value e.g., 0 or 1, transmit or not transmit, error or no error, etc. In one example, the last code book entry (e.g., entry N−1, when counting starts from 0) can be default entry, e.g., used to indicate a CBG combination not provided by the other entries. In one example, the last code book entry (e.g., entry N−1, when counting starts from 0) can have f_{N-1,j}=1 for j=0, 1, . . . , M−1. In one example, the last code book entry (e.g., entry N−1, when counting starts from 0) can indicate a CBG error pattern not provided by the remaining N−1 entries. In one example, the last code book entry (e.g., entry N−1, when counting starts from 0) can indicate a transmission for CBGs. In one example, the last code book entry (e.g., entry N−1, when counting starts from 0) can indicate flushing for CBGs. In one example, the last code book entry (e.g., entry N−1, when counting starts from 0) can indicate a transmission for CBGs.

TABLE 2

| Code book index | CBG 0 | CBG 1 | CBG 2 | CBG 3 |
|---|---|---|---|---|
| 0 | f_{0, 0} | f_{0, 1} | f_{0, 2} | f_{0, 3} |
| 1 | f_{1, 0} | f_{1, 1} | f_{1, 2} | f_{1, 3} |
| 2 | f_{2, 0} | f_{2, 1} | f_{2, 2} | f_{2, 3} |
| 3 | f_{3, 0} | f_{3, 1} | f_{3, 2} | f_{3, 3} |
| 4 | f_{4, 0} | f_{4, 1} | f_{4, 2} | f_{4, 3} |
| 5 | f_{5, 0} | f_{5, 1} | f_{5, 2} | f_{5, 3} |
| 6 | f_{6, 0} | f_{6, 1} | f_{6, 2} | f_{7, 3} |
| 7 | f_{7, 0} | f_{7, 1} | f_{6, 2} | f_{7, 3} |

In one example, when the CBG code book is used for HARQ-ACK feedback, the size of the HARQ-ACK field is n bits. In one example, n=┌log₂ N┐. In one example, if entry i is signaled in the HARQ-ACK feedback, flag f_{i,j} corresponding to CBG index j of entry i determines whether or not the CBG has a decode error. In one example, if f_{i,j}=0, CBG j of entry i has no decode error, and if f_{i,j}=1, CBG j of entry i has a decode error. In one example, if f_{i,j}=1, CBG j of entry i has no decode error, and if f_{i,j}=0, CBG j of entry i has a decode error.

In one example, if UE configured with CBGs for PDSCH (CBG-based PDSCH), e.g., UE is provided higher layer parameter PDSCH-CodeBlockGroupTransmission for PDSCH, the HARQ-ACK feedback provides an entry index of the CBG code book using n-bits as aforementioned. In one example, if a UE is not configured with CBGs for PDSCH, UE is not provided higher layer parameter PDSCH-CodeBlockGroupTransmission for PDSCH, the HARQ-ACK feedback for a transport block can be one-bit.

In one example, when the CBG code book is used to indicate which CBG to transmit, for example as a field in a DCI Format. In one example, the field is CBG transmission indicator (CBGTI). In one example, the DCI Format is for scheduling a DL transmission (e.g., PDSCH). In one example, the DCI Format is for scheduling an UL transmission (e.g., PUSCH). In one example, the size of the field (e.g., CBGTI) is n bits. In one example, n=┌log₂ N┐. In one example, if entry i is signaled in the DCI field (e.g., CBGTI), flag f_{i,j} corresponding to CBG index j of entry i determines whether or not the CBG is transmitted. In one example, if f_{i,j}=0, CBG j of entry i is not transmitted, and if f_{i,j}=1, CBG j of entry i is transmitted. In one example, if f_{i,j}=1, CBG j of entry i is not transmitted, and if f_{i,j}=0, CBG j of entry i is transmitted. In one example, a code block entry corresponding to no transmissions on CBGs is excluded from the code book used for CBGTI signaling. In one example, a code block entry corresponding to no transmissions on CBGs is excluded from the code book used for CBGTI signaling, and code book index of remaining entries is adjusted after excluding the entry corresponding to no transmissions on CBGs (e.g., entry N comes entry N−1 for remaining entries after entry corresponding to no transmissions on CBGs).

In one example, if UE configured with CBGs for PDSCH (CBG-based PDSCH), e.g., UE is provided higher layer parameter PDSCH-CodeBlockGroupTransmission for PDSCH, a field (e.g., CBGTI) is included in the DCI Format (e.g., DL related DCI Format, e.g., DCI Format 1_1) to indicate the transmitted PDSCH CBGs as aforementioned. In one example, if a UE is not configured with CBGs for PDSCH, UE is not provided higher layer parameter PDSCH-CodeBlockGroupTransmission for PDSCH, there is no field (0 bits for the field or the field is reserved) in DCI Format to indicate the transmitted PDSCH CBGs.

In one example, if UE configured with CBGs for PUSCH (CBG-based PUSCH), e.g., UE is provided higher layer parameter PUSCH-CodeBlockGroupTransmission for PUSCH, a field (e.g., CBGTI) is included in the DCI Format (e.g., DL related DCI Format, e.g., DCI Format 0_1) to indicate the transmitted PUSCH CBGs as aforementioned. In one example, if a UE is not configured with CBGs for PUSCH, UE is not provided higher layer parameter PUSCH-CodeBlockGroupTransmission for PUSCH, there is no field (0 bits for the field or the field is reserved) in DCI Format to indicate the transmitted PUSCH CBGs.

In one example, when the CBG code book is used to indicate which CBGs can be combined with earlier received instances of the same CBGs or not, for example as a field in a DCI Format. In one example, the field is CBG flushing out information (CBGFI). In one example, the DCI Format is for scheduling a DL transmission (e.g., PDSCH). In one example, the size of the field (e.g., CBGFI) is n bits. In one example, n=┌log₂ N┐. In one example, if entry i is signaled in the DCI field (e.g., CBGFI), flag f_{i,j} corresponding to CBG index j of entry i determines whether or not the CBG is combined with earlier received instances of the same CBG. In one example, if f_{i,j}=0, CBG j of entry i is not combined with earlier received instances of same CBG (earlier received instances are flushed, e.g., earlier instances maybe corrupted), and if f_{i,j}=1, CBG j of entry i is combined with earlier received instances of same CBG. In one example, if f_{i,j}=1, CBG j of entry i is not combined with earlier received instances of same CBG (earlier received instances are flushed, e.g., earlier instances maybe corrupted), and if f_{i,j}=0, CBG j of entry i is combined with earlier received instances of same CBG.

In one example, CBGFI is one bit, and is used to indicate whether or not CBGs can be combined with earlier received instances of the same CBGs.

In one example, if UE (e.g., the UE 116) configured with CBGs for PDSCH (CBG-based PDSCH), e.g., UE is provided higher layer parameter PDSCH-CodeBlockGroupTransmission for PDSCH and/or higher layer parameter codeBlockGroupFlushIndicator, a field (e.g., CBGFI) is included in the DCI Format (e.g., DL related DCI Format, e.g., DCI Format 1_1) to indicate whether or not to flush earlier received CBGs (per CBG index or for CBGs) as aforementioned. In one example, if a UE is not configured with CBGs for PDSCH, UE is not provided higher layer parameter PDSCH-CodeBlockGroupTransmission and/or higher layer parameter codeBlockGroupFlushIndicator for PDSCH, there is no field (0 bits for the field or the field is reserved) to indicate whether or not to flush earlier received CBGs.

In one example, a same CBG code book can be used or configured for HARQ-ACK feedback and/or CBGTI and/or CBGFI (if applicable) for PDSCH.

In one example a CBG code book for HARQ-ACK feedback signaling includes an entry (e.g., code book index or code point) corresponding to ACK on CBGs, and a CBG code book for CBGTI signaling includes an entry (e.g., code book index or code point) corresponding to no transmission on CBGs. In one example, the UE doesn't expect to be signaled on CBGTI a code book index or code point corresponding to no transmission on CBGs.

In one example a CBG code book for HARQ-ACK feedback signaling includes an entry (e.g., code book index or code point) corresponding to ACK on CBGs, and a CBG code book for CBGTI signaling doesn't include an entry (e.g., code book index or code point) corresponding to no transmission on CBGs.

In one example, different CBG code books can be used or configured for HARQ-ACK feedback and CBGTI and CBGFI (if applicable) for PDSCH.

In one example, a same CBG code book can be used or configured for HARQ-ACK feedback and/or CBGTI and/or CBGFI (if applicable) for PDSCH and/or CBGTI for PUSCH.

In one example, different CBG code books can be used or configured for HARQ-ACK feedback and CBGTI and CBGFI (if applicable) for PDSCH and/or CBGTI for PUSCH.

In one example, the network can configure CBG code book as aforementioned, or use CBG operation as described herein in this disclosure. In one example, and the UE interprets the HARQ-ACK feedback payload based on the configured size of CBGTI/CBGFI.

In one example, a CBG code book is determined (at least in part) based on a rule. In one example, the rule can be specified in the system specifications. In one example, the rule can be configured and/or updated by higher layer signaling (e.g., RRC-based signaling and/or SIB-signaling) and/or MAC CE signaling and/or L1 control (e.g., DCI Format) signaling.

In one example, a CBG code-block can indicate up to K CBGs (e.g., K CBGs in error or K CBGs transmitted). In one example, a CBG code book can include N entries. In one example, N=2ⁿ, wherein n can be a positive integer. In one example, the CBG code book entries include:
One entry for no CBGs indicated. In one example, this entry has index i=0. In one example, field f_{i,j} for entry i (e.g., i=0) and CBG index j, where j=0, 1, . . . , M−1 is given by f_{i,j}=0. In one example, f_{i,j}=0 indicates a positive acknowledgment for corresponding CBG (e.g., CBG j). In one example, f_{i,j}=0 indicates no transmission for corresponding CBG (e.g., CBG j).
M entries for indicating one CBG. In one example, for CBG index J, corresponding codebook entry is I=1+s, where s=0, 1, . . . , M−1 and s is unique for each J. In one example, s=J. In one example, for CBG index J, corresponding codebook entry is I, where, I=J+1, and f_{j+1,j}=1 for j=J, and f_{j+1,j}=0 for j #J. In one example, f_{i,j}=0 indicates a positive acknowledgment for corresponding CBG (e.g., CBG j). In one example, f_{i,j}=1 indicates a negative acknowledgment for corresponding CBG (e.g., CBG j). In one example, f_{i,j}=0 indicates no transmission for corresponding CBG (e.g., CBG j). In one example, f_{i,j}=1 indicates transmission for corresponding CBG (e.g., CBG j).

$$\frac{M ( M - 1 )}{2 !}$$

entries for indicating two CBGs. In one example, for the first entry indicating two CBGs starts at I₂, wherein I₂=M+1. In one example, for CBG index J₁ and CBG index J₂, corresponding codebook entry is 2=I₂+s, where s=0, 1, . . . ,

$$\frac{M ( M - 1 )}{2 !} - 1$$

and s is unique for each pair of J₁ and J₂, with J₂>J₁. In one example,

$$s = {\sum }_{k = 0}^{2 - 1} ( \begin{matrix}{J}_{k} \\ K - k\end{matrix} ) .$$

In one example,

$$( \begin{matrix}a \\ b\end{matrix} ) = 0 ,$$

if a<b. In one example, f_{I}_{₂}_{+s,j}=1, if j=J₁ or j=J₂ and f_{I}_{₂}_{+s,j}=0, or values of j other than J₁ and J₂. In one example, f_{i,j}=0 indicates a positive acknowledgment for corresponding CBG (e.g., CBG j). In one example, f_{i,j}=1 indicates a negative acknowledgment for corresponding CBG (e.g., CBG j). In one example, f_{i,j}=0 indicates no transmission for corresponding CBG (e.g., CBG j). In one example, f_{i,j}=1 indicates transmission for corresponding CBG (e.g., CBG j).

$$\frac{M ( M - 1 ) … ( M - K )}{K !}$$

entries for indicating K CBGs. In one example, for the first entry indicating two CBGs starts at I_{K}, wherein

$${I}_{K} = {\sum }_{i = 0}^{K - 1} ( \begin{matrix}M \\ i\end{matrix} ) .$$

In one example, for CBG index J₁, CBG index J₂, . . . , CBG index J_{K} corresponding codebook entry is I=I_{K}+s, where

$$s = 0 , 1 , … , \frac{M ( M - 1 ) … ( M - K )}{K !} - 1$$

and s is unique for each set of J₁, J₂ and J_{K} with J_{K}> . . . >J₂>J₁. In one example,

$$s = {\sum }_{k = 0}^{K - 1} ( \begin{matrix}{J}_{k} \\ K - k\end{matrix} ) .$$

In one example,

$$( \begin{matrix}a \\ b\end{matrix} ) = 0 ,$$

if a<b. In one example, f_{I}_{_{K}}_{+s,j}=1, if j=J₁ or j=J₂ . . . or j=J_{K} and f_{I}_{₂}_{+s,j}=0, or values of j other than J₁, J₂, . . . J_{K}. In one example, f_{i,j}=0 indicates a positive acknowledgment for corresponding CBG (e.g., CBG j). In one example, f_{i,j}=1 indicates a negative acknowledgment for corresponding CBG (e.g., CBG j). In one example, f_{i,j}=0 indicates no transmission for corresponding CBG (e.g., CBG j). In one example, f_{i,j}=1 indicates transmission for corresponding CBG (e.g., CBG j).
One entry indicating any other CBG pattern, or indicating transmission in other CBG patterns. In one example, the last code book entry can be default entry, e.g., used to indicate a CBG combination not provided by the other entries. In one example, the last code book entry can have f_{N-1,j}=1 for j=0, 1, . . . , M−1. In one example, the last code book entry can indicate a CBG error pattern not provided by the remaining N−1 entries. In one example, the last code book entry can indicate a transmission for CBGs. In one example, the last code book entry can indicate flushing for CBGs. In one example, the last code book entry can indicate a transmission for CBGs. In one example, the index of this entry is

$${\sum }_{i = 0}^{K} ( \begin{matrix}M \\ i\end{matrix} ) ,$$

e.g., when the first code book entry has index 0. In one example, the index of this entry is N−1, e.g., when the first code book entry has index 0.
In the aforementioned examples, the interpretation of 1 and 0 can be reversed.

In one example, the number of entries in the code book are

$$N = 1 + {\sum }_{i = 0}^{K} ( \begin{matrix}M \\ i\end{matrix} ) .$$

In one example,

$$N \geq 1 + {\sum }_{i = 0}^{K} ( \begin{matrix}M \\ i\end{matrix} ) ,$$

for example, N can be rounded up such that N=2ⁿ. In one example, if

$$N > 1 + {\sum }_{i = 0}^{K} ( \begin{matrix}M \\ i\end{matrix} ) ,$$

code book entries not allocated (e.g., beyond the

$$1 + {\sum }_{i = 0}^{K} ( \begin{matrix}M \\ i\end{matrix} )$$

entries) are not used (e.g., reserved). In one example, if

$$N > 1 + {\sum }_{i = 0}^{K} ( \begin{matrix}M \\ i\end{matrix} ) ,$$

code book entries not allocated (e.g., beyond

$$1 + {\sum }_{i = 0}^{K} ( \begin{matrix}M \\ i\end{matrix} )$$

entries) are configured as described herein in this disclosure. For example, any entry i beyond the

$$1 + {\sum }_{i = 0}^{K} ( \begin{matrix}M \\ i\end{matrix} )$$

entries determined herein, can be configured a flag (e.g., f_{i,j}) for the M CBGs, wherein j=0, 1, . . . , M−1, or j=1, 2, . . . , M.

In one example, N=8, M=6, and K=1. The code book for CBGs is given by Table 3. In one example, f_{i,j}=0 in Table 3 indicates a positive acknowledgment for corresponding CBG (e.g., CBG j). In one example, f_{i,j}=1 in Table 3 indicates a negative acknowledgment for corresponding CBG (e.g., CBG j). In one example, f_{i,j}=0 in Table 3 indicates no transmission for corresponding CBG (e.g., CBG j). In one example, f_{i,j}=1 in Table 3 indicates transmission for corresponding CBG (e.g., CBG j). In one example, the last entry in Table 3 is an entry (e.g., default entry) that can be used to indicate a CBG combination not indicated by any of the other entries of Table 3 (e.g., for HARQ-ACK feedback). In one example, the last entry in Table 3 can be used to indicate transmission on CBGs.

TABLE 3

| Code book | | | | | | |
|---|---|---|---|---|---|---|
| index | CBG 0 | CBG 1 | CBG 2 | CBG 3 | CBG 4 | CBG 5 |
| 0 | 0 | 0 | 0 | 0 | 0 | 0 |
| 1 | 1 | 0 | 0 | 0 | 0 | 0 |
| 2 | 0 | 1 | 0 | 0 | 0 | 0 |
| 3 | 0 | 0 | 1 | 0 | 0 | 0 |
| 4 | 0 | 0 | 0 | 1 | 0 | 0 |
| 5 | 0 | 0 | 0 | 0 | 1 | 0 |
| 6 | 0 | 0 | 0 | 0 | 0 | 1 |
| 7 | 1 | 1 | 1 | 1 | 1 | 1 |

In one example, N=8, M=4, and K=1. The code book for CBGs is given by Table 4 or Table 5. In one example, f_{i,j}=0 in Table 4 or Table 5 indicates a positive acknowledgment for corresponding CBG (e.g., CBG j). In one example, f_{i,j}=1 in Table 4 or Table 5 indicates a negative acknowledgment for corresponding CBG (e.g., CBG j). In one example, f_{i,j}=0 in Table 4 or Table 5 indicates no transmission for corresponding CBG (e.g., CBG j). In one example, f_{i,j}=1 in Table 4 or Table 5 indicates transmission for corresponding CBG (e.g., CBG j).

In one example, entry 5 in Table 4 is an entry (e.g., default entry) that can be used to indicate a CBG combination not indicated by any of the other entries of Table 4 (e.g., for HARQ-ACK feedback). In one example, the entry 5 in Table 4 can be used to indicate transmission on CBGs. In one example, the remaining entries (e.g., entry 6 and entry 7) of Table 4 not determined by rules herein can be configured by network.

In one example, last entry in Table 5 is an entry (e.g., default entry) that can be used to indicate a CBG combination not indicated by any of the other entries of Table 4 (e.g., for HARQ-ACK feedback). In one example, the last entry in Table 4 can be used to indicate transmission on CBGs. In one example, the remaining entries (e.g., entry 6 and entry 7) of Table 5 not determined by rules herein can be configured by network.

TABLE 4

| Code book index | CBG 0 | CBG 1 | CBG 2 | CBG 3 |
|---|---|---|---|---|
| 0 | 0 | 0 | 0 | 0 |
| 1 | 1 | 0 | 0 | 0 |
| 2 | 0 | 1 | 0 | 0 |
| 3 | 0 | 0 | 1 | 0 |
| 4 | 0 | 0 | 0 | 1 |
| 5 | 1 | 1 | 1 | 1 |
| 6 | f_{6, 0} | f_{6, 1} | f_{6, 2} | f_{6, 3} |
| 7 | f_{7, 0} | f_{7, 1} | f_{7, 2} | f_{7, 3} |

TABLE 5

| Code book index | CBG 0 | CBG 1 | CBG 2 | CBG 3 |
|---|---|---|---|---|
| 0 | 0 | 0 | 0 | 0 |
| 1 | 1 | 0 | 0 | 0 |
| 2 | 0 | 1 | 0 | 0 |
| 3 | 0 | 0 | 1 | 0 |
| 4 | 0 | 0 | 0 | 1 |
| 5 | f_{5, 0} | f_{5, 1} | f_{5, 2} | f_{5, 3} |
| 6 | f_{6, 0} | f_{6, 1} | f_{6, 2} | f_{6, 3} |
| 7 | 1 | 1 | 1 | 1 |

In one example, remaining entries of Table 4 or Table 5 can follow a predefined rule.

One example, of a predefined rule is to after the entry defined by rules herein or last entry indicating K CBGs (in the example, of Table 4 and Table 5, K=1), continue with code book entries indicating K+1, in the aforementioned order, until code book entries are used.

In one example, for Table 4:

$${f}_{6 , 0} = 1 , {f}_{6 , 1} = 1 , {f}_{6 , 2} = 0 , and {f}_{6 , 3} = 0.$$

$${f}_{7 , 0} = 1 , {f}_{7 , 1} = 0 , {f}_{7 , 2} = 1 , and {f}_{7 , 3} = 0 .$$

In one example, for Table 5:

$${f}_{5 , 0} = 1 , {f}_{5 , 1} = 1 , {f}_{5 , 2} = 0 , and {f}_{5 , 3} = 0.$$

$${f}_{6 , 0} = 1 , {f}_{6 , 1} = 0 , {f}_{6 , 2} = 1 , and {f}_{6 , 3} = 0 .$$

In one example, the number of CBGs, M, is configured and/or updated by higher signaling (e.g., RRC-based signaling and/or SIB-signaling) and/or MAC CE signaling and/or L1 control (e.g., DCI Format) signaling. In one example, a same value of M is used for PDSCH and PUSCH. In one example, different values of M are configured and/or updated for PDSCH and PUSCH. In one example, a same value of M is used for PDSCH HARQ-ACK codebook and/or CBGTI and/or (if applicable) CBGFI. In one example, different values of M are used for PDSCH HARQ-ACK codebook and CBGTI and (if applicable) CBGFI.

In one example, the number of CBG code book entries, N, is configured and/or updated by higher signaling (e.g., RRC-based signaling and/or SIB-signaling) and/or MAC CE signaling and/or L1 control (e.g., DCI Format) signaling. In one example, a same value of N is used for PDSCH and PUSCH. In one example, different values of N are configured and/or updated for PDSCH and PUSCH. In one example, a same value of N is used for PDSCH HARQ-ACK codebook and/or CBGTI and/or (if applicable) CBGFI. In one example, different values of N are used for PDSCH HARQ-ACK codebook and CBGTI and (if applicable) CBGFI.

In one example, the number of CBGs to indicate, K, is specified in the system specifications and/or configured and/or updated by higher signaling (e.g., RRC-based signaling and/or SIB-signaling) and/or MAC CE signaling and/or L1 control (e.g., DCI Format) signaling. In one example, a same value of K is used for PDSCH and PUSCH. In one example, different values of K are configured and/or updated for PDSCH and PUSCH. In one example, a same value of K is used for PDSCH HARQ-ACK codebook and/or CBGTI and/or (if applicable) CBGFI. In one example, different values of K are used for PDSCH HARQ-ACK codebook and CBGTI and (if applicable) CBGFI.

In one example, N can be determined based on K and M. In one example,

$$N = 1 + {\sum }_{i = 0}^{K} ( \begin{matrix}M \\ i\end{matrix} ) .$$

In one example,

$$N \geq 1 + {\sum }_{i = 0}^{K} ( \begin{matrix}M \\ i\end{matrix} ) ,$$

for example, N can be rounded up such that N=2ⁿ.

In one example, K can be determined based on M and N. In one example, K is the largest integer for which

$$N \geq 1 + {\sum }_{i = 0}^{K} ( \begin{matrix}M \\ i\end{matrix} ) ,$$

in one example, the unallocated values of the N code book entries are reserved or configured or determined as aforementioned. In one example, K is the smallest integer for which

$$N \leq 1 + {\sum }_{i = 0}^{K} ( \begin{matrix}M \\ i\end{matrix} ) ,$$

in one example, only a subset (e.g., corresponding to the smallest indices) of the K CBGs can be indicated using the CBG code book, in a variant example, subset of K CBGs can first indicate code book entries where the K CBGs are consecutive, then code book entries where the K CBGs are not consecutive.

In one example, M can be determined based on K and N. In one example, M is the largest integer for which

$$N \geq 1 + {\sum }_{i = 0}^{K} ( \begin{matrix}M \\ i\end{matrix} ) ,$$

in one example, the unallocated values of the N code book entries are reserved or configured or determined as aforementioned.

In one example, a code book for CBGTI signaling includes an entry (e.g., code book index or code point) corresponding to no transmission on CBGs. In one example, the UE doesn't expect to be signaled on CBGTI a code book index or code point corresponding to no transmission on CBGs.

In one example, a code book for CBGTI signaling doesn't include an entry (e.g., code book index or code point) corresponding to no transmission on CBGs.

In one example, the network (e.g., the network 130) can configure the UE to determine the CBG code book as aforementioned, or use CBG operation as described herein in this disclosure. In one example, and the UE interprets the HARQ-ACK feedback payload based on the configured size of CBGTI/CBGFI. In one example, the UE determines operation based on CBG code book as aforementioned or based on CBG operation based on the size of CBGTI/CBGFI field. In one example, if the CBGTI field is n-bits, and the number of CBGs M=n or M≤n, the UE can use CBG-based operation. In one example, if the CBGTI field is n-bits, and the number of CBGs M>n, the UE can use the CBG code block as described in this disclosure.

In one example, the UE determines operation based on CBG code book as aforementioned or based on CBG operation based on the size of HARQ-ACK feedback. In one example, if the HARQ-ACK feedback for a transport block is n-bits, and the number of CBGs M=n or M≤n, the UE can use CBG-based operation. In one example, if the HARQ-ACK feedback for a transport block is n-bits, and the number of CBGs M>n, the UE can use the CBG code block as described in this disclosure.

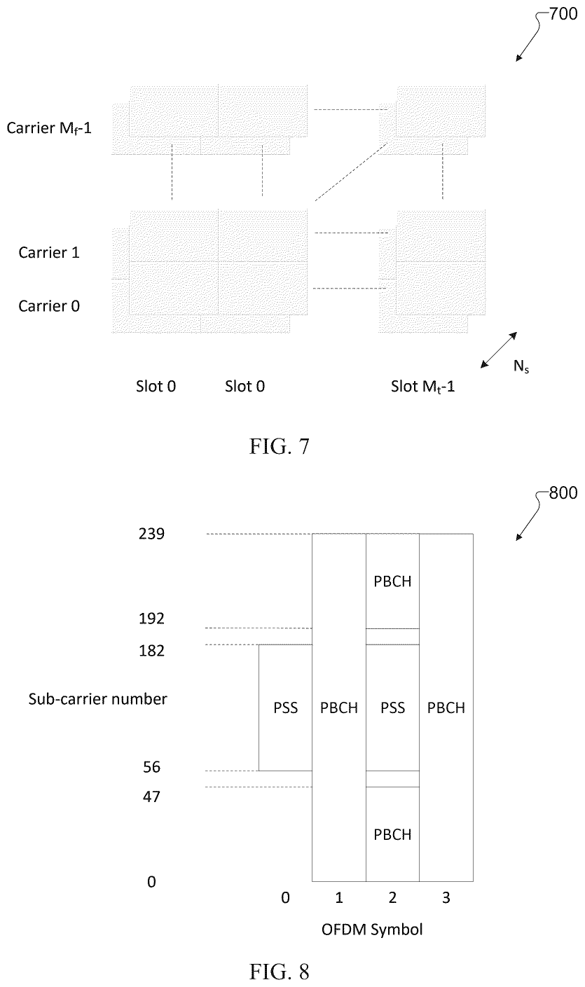

FIG. 7 illustrates an example of multiple slots/carriers 700 according to embodiments of the present disclosure. For example, any of the UEs 111-116 of FIG. 1 can use multiple slots/carriers 700 for reception. This example is for illustration only and other embodiments can be used without departing from the scope of the present disclosure.

In one example, a UE can receive PDSCH over multiple (e.g., Mₜ) slots (or time units) and/or over multiple (e.g., M_{f}) carriers (or frequency units) and/or a slot/carrier (time/frequency unit) and/or can include multiple (e.g., Mₛ) transport blocks (TBs) and/or CBs or CBGs as illustrated in FIG. 7. In one example, at least one of Mₜ or M_{f} or Mₛ is greater than 1.

In one example, the PDSCH is scheduled (e.g., for transmission or retransmission) using a single DCI, wherein the DCI includes a field indicating which of the Mₜ×M_{f}×Mₛ TBs/CBs/CBGs or Mₜ×M_{f} PDSCHes are transmitted for brevity, this field is denoted as transmission indicator (TI).

In one example, the PDSCH is scheduled (e.g., for transmission or retransmission) using a single DCI, wherein the DCI includes a field indicating which of the Mₜ×M_{f}×Mₛ TBs/CBs/CBGs or Mₜ×M_{f} PDSCHes can be combined with a previous corresponding instance (no corruption), or can't be combined with a previous corresponding instance (e.g., flush buffer, e.g., due to corruption) for brevity, this field is denoted as flushing indicator (FI).

In one example, the HARQ-ACK for the PDSCH corresponds to a HARQ code book with entries corresponding to the decoding error status of Mₜ×M_{f}×Mₛ TBs/CBs/CBGs or Mₜ×M_{f} PDSCHes.

In one example, a UE can transmit PUSCH over multiple (e.g., Mₜ) slots (or time units) and/or over multiple (e.g., M_{f}) carriers (or frequency units) and/or a slot/carrier (time/frequency unit) and/or can include multiple (e.g., Mₛ) transport blocks (TBs) and/or CBs or CBGs as illustrated in FIG. 7. In one example, at least one of Mₜ or M_{f} or Mₛ is greater than 1.

In one example, the PUSCH is scheduled (e.g., for transmission or retransmission) using a single DCI, wherein the DCI includes a field indicating which of the Mₜ×M_{f}×Mₛ TBs/CBs/CBGs or Mₜ×M_{f} PUSCHes are transmitted for brevity, this field is denoted as transmission indicator (TI).

Without any loss of generalization, Mₛ=1, i.e., single TB or CBG in a slot/carrier (or time/frequency unit), however, this can be extended to case of Mₛ>1.

In one example, a network can configure and a UE can receive a configuration of a PDSCH/PUSCH code book(s). In one example, a PDSCH/PUSCH code book(s) can include N entries. In one example, N=2ⁿ, wherein n can be a positive integer. In one example, for an entry with index i belonging to the code book, wherein i=0, 1, . . . , N−1, or i=1, 2, . . . , N, for each PDSCH/PUSCH of the M PDSCHes or PUSCHes a flag (e.g., f_{i,j}) is configured, for example, the flag can be configured, wherein j is the index of the PSDCH/PUSCH, wherein j=0, 1, . . . , M−1, or i=1, 2, . . . , M. In one example, M=Mₜ×M_{f}. In one example, M=Mₜ. In one example, M=M_{f}. In one example, the index j can be counted (e.g., starting from 0 or starting from 1) first over the Mₜ slots or time units, then over the M_{f} carriers or frequency units. In one example, the index j can be counted (e.g., starting from 0 or starting from 1) first over the M_{f} carriers or frequency units, then over the Mₜ slots or time units. In one example, the index j can be counted (e.g., starting from 0 or starting from 1) over the Mₜ slots or time units. In one example, the index j can be counted (e.g., starting from 0 or starting from 1) over the M_{f} carriers or frequency units.

The examples of embodiments herein can apply to the case of PDSCH scheduling and HARQ-ACK feedback over a group of M=Mₜ×M_{f} slot/carrier or time/frequency units, wherein the PDSCH replaces the PDSCH CBG, the TI in DCI format scheduling PDSCH replaces the CBGTI in a DCI format scheduling PDSCH, the FI in DCI format scheduling PDSCH replaces the CBGFI in a DCI format scheduling PDSCH, and the HARQ-ACK feedback for multiple PDSCHes replaces the CBG HARQ-ACK feedback.

The examples of embodiments herein can apply to the case of PUSCH scheduling over a group of M=Mₜ×M_{f} slot/carrier or time/frequency units, wherein the PUSCH replaces the PUSCH CBG and the TI in DCI format scheduling PUSCH replaces the CBGTI in a DCI format scheduling PUSCH.

In one example, a PDSCH/PUSCH code book(s) is determined (at least in part) based on a rule. In one example, the rule can be specified in the system specifications. In one example, the rule can be configured and/or updated by higher signaling (e.g., RRC-based signaling and/or SIB-signaling) and/or MAC CE signaling and/or L1 control (e.g., DCI Format) signaling. In one example, a PDSCH/PUSCH code-block(s) can indicate up to K PDSCHes or up to K PUSCHes (e.g., K PDSCHes in error or K PDSCHes or PUSCHes transmitted). In one example, a PDSCH/PUSCH code book can include N entries. In one example, N=2ⁿ, wherein n can be a positive integer.

The examples of embodiments herein can apply to the case of PDSCH scheduling and HARQ-ACK feedback over a group of M=Mₜ×M_{f} slot/carrier or time/frequency units, wherein the PDSCH replaces the PDSCH CBG, the TI in DCI format scheduling PDSCH replaces the CBGTI in a DCI format scheduling PDSCH, the FI in DCI format scheduling PDSCH replaces the CBGFI in a DCI format scheduling PDSCH, and the HARQ-ACK feedback for multiple PDSCHes replaces the CBG HARQ-ACK feedback.

The examples of embodiments herein can apply to the case of PUSCH scheduling over a group of M=Mₜ×M_{f} slot/carrier or time/frequency units, wherein the PUSCH replaces the PUSCH CBG and the TI in DCI format scheduling PUSCH replaces the CBGTI in a DCI format scheduling PUSCH.

In one example, a code book for TI signaling includes an entry (e.g., code book index or code point) corresponding to no transmission on PDSCHes or PUSCHes. In one example, the UE doesn't expect to be signaled on TI a code book index corresponding to no transmission on PDSCHes or PUSCHes.

In one example, a code book for TI signaling doesn't include an entry (e.g., code book index or code point) corresponding to no transmission on PDSCHes or PUSCHes.

A time unit for DL signaling, for UL signaling, or for SL signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. As another example, a slot can have a duration of 0.25 milliseconds and include 14 symbols and an RB can have a BW of 720 kHz and include 12 SCs with SC spacing of 60 kHz. An RB in one symbol of a slot is referred to as physical RB (PRB) and includes a number of resource elements (REs). A slot can be either full DL slot, or full UL slot, or hybrid slot similar to a special sub-frame in time division duplex (TDD) systems (see also REF 1). In addition, a slot can have symbols for SL communications. A UE can be configured one or more bandwidth parts (BWPs) of a system BW for transmissions or receptions of signals or channels.

FIG. 8 illustrates an example SS/PBCH 800 block according to embodiments of the present disclosure. For example, SS/PBCH 800 block can be received by any of the UEs 111-116 of FIG. 1, such as the UE 111. This example is for illustration only and other embodiments can be used without departing from the scope of the present disclosure.

In 5G/NR, a UE (e.g., the UE 116) performs the cell search procedure to acquire time and frequency synchronization with a cell and to detect the physical layer Cell ID of the cell. To perform cell search, the UE receives the following signals and channel: (1) the primary synchronization signal (PSS), (2) the secondary synchronization signal (SSS) and (3) the physical broadcast channel (PBCH). A PSS/SSS/PBCH block (SS/PBCH block) is referred to as SSB and includes 4 consecutive symbols, and 20 physical resource blocks (240 subcarriers), as illustrated in FIG. 8.

SSBs are organized in groups or bursts of up to N SSBs, transmitted within half a frame, each SSB within the group or burst has an index i, where i=0, 1, . . . , N−1, within each group or burst of SSBs, the SSBs are time-division multiplexed and arranged in increasing order of i, with increasing time. For carrier frequencies less than or equal to 3 GHz, N=4. For carrier frequencies in FR1 that are larger than 3 GHz, N=8. For carrier frequencies in FR2, N=64. The SSB indices actually transmitted are provided by ssb-PositionsInBurst in system information block one (SIB1) or in ServingCellConfigCommon or in SSB-MTC-AdditionalPCI or in LTM-SSB-Config.

SSBs are transmitted periodically, where the allowed periodicities are {5, 10, 20, 40, 80, 160} ms. In addition to cell search, SSBs can also be used for beam management related procedures, such as new beam acquisition, beam measurements, and beam failure detection and recovery. Each SSB with index i can be associated with a spatial domain filter (or beam).

NR introduced a physical random access channel (PRACH) to be used, among other cases, when the UE wants to communicate with the network and doesn't have uplink resources. For example, the physical random access channel can be used during initial access. The PRACH includes a preamble format comprising one or more preamble sequences transmitted in a PRACH Occasion (RO).

NR supports four different preamble sequence lengths:
Sequence length 839 used with sub-carrier spacings 1.25 kHz and 5 kHz with unrestricted or restricted sets.
Sequence length 139 used with sub-carrier spacings 15 kHz, 30 kHz, 60 kHz and 120 kHz with unrestricted sets.
Sequence length 571 used with sub-carrier spacing 30 kHz with unrestricted sets.
Sequence length 1151 used with sub-carrier spacing 15 kHz with unrestricted sets.

RACH preambles are transmitted in time-frequency resources referred to as PRACH Occasions (ROs). Each RO determines the time and frequency resources in which a preamble is transmitted, the resources allocated to an RO in the frequency domain (e.g., number of RBs) and the resource allocated to an RO in the time domain (e.g., number of OFDMA symbols or number of slots), depend on the preamble sequence length, sub-carrier spacing of the preamble, sub-carrier spacing of the PUSCH in the UL BWP, and the preamble format. Multiple PRACH Occasions can be FDMed in one-time instance. This is indicated by higher layer parameter msg1-FDM. The time instances of the PRACH Occasions are determined by the higher layer parameter prach-ConfigurationIndex, and Tables 6.3.3.2-2, 6.3.3.2-3, and 6.3.3.2-4 of [REF 1].

SSBs are associated with ROs. The number of SSBs associated with one RO can be indicated by higher layer parameters such as ssb-perRACH-OccasionAndCB-PreamblesPerSSB and ssb-perRACH-Occasion. The number of SSBs per RO can be {1/8,1/4,1/2,1,2,4,8,16}. When the number of SSBs per RO is less than 1, multiple ROs are associated with the same SSB index. SS/PBCH block indexes provided by ssb-PositionsInBurst in SIB1 or in ServingCellConfigCommon are mapped to valid PRACH occasions in the following order [REF 3]:
First, in increasing order of preamble indexes within a single PRACH occasion.
Second, in increasing order of frequency resource indexes for frequency multiplexed PRACH occasions.
Third, in increasing order of time resource indexes for time multiplexed PRACH occasions within a PRACH slot.
Fourth, in increasing order of indexes for PRACH slots.

The association period starts from frame 0 for mapping SS/PBCH block indexes to PRACH Occasions.

In certain embodiments, 5G NR air interface supports time-division duplex (TDD) operation and frequency division duplex (FDD) operation. Use of FDD or TDD depends on the NR frequency band and per-country allocations. TDD is required in most bands above 2.5 GHz.

In TDD, symbols and/or slots can be configured as DL symbols and/or slots or as UL symbols and/or slots or as flexible symbols and/or slots. Wherein, flexible symbols and/or slots can be used as DL or UL depending on signaling and configuration. Rel-19 introduced, sub-band full duplex (SBFD) operation, wherein a symbol or a slot can be used for DL and UL, one or more sub-bands within the symbol or slot is configured for DL operation and one sub-band within the symbol or slot is configured for UL operation.

In NR, there are three-levels of slot configuration; (1) Cell-common semi-static TDD UL-DL configuration, (2) UE-dedicated semi-static TDD UL-DL configuration, and (3) dynamic TDD UL-DL configuration.

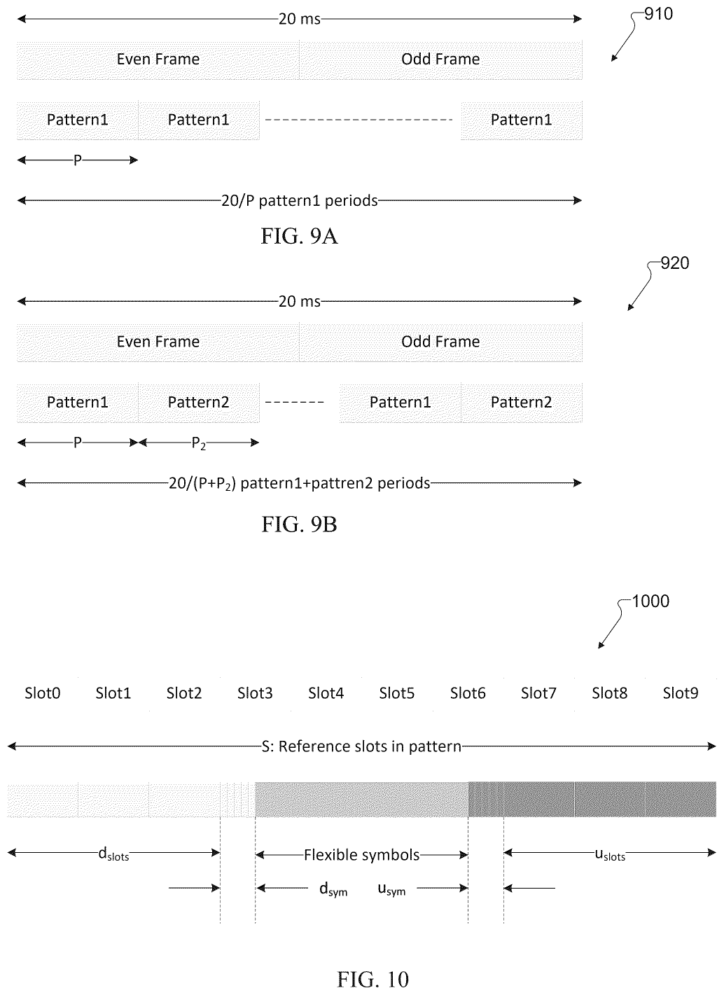

FIGS. 9A and 9B illustrate an UL DL configuration 910 and 920 according to embodiments of the present disclosure. For example, UL DL configuration 910 and 920 can be implemented in the wireless network 100 of FIG. 1. This example is for illustration only and other embodiments can be used without departing from the scope of the present disclosure.

Cell-common semi-static TDD UL-DL configuration (TDD-UL-DL-ConfigCommon) includes one or two patterns, pattern1 and pattern2, wherein the first of an even frame is the start of pattern1, as illustrated in FIG. 9(A), when only pattern1 is configured and FIG. 9(B) when pattern1 and pattern2 are configured. If only pattern1 is configured 20/P is an integer, which determines the number of pattern1 periods within 2 frames, wherein P is the period of pattern1 in ms. If pattern1 and pattern2 are configured 20/(P+P₂) is an integer, which determines the number of pattern1+pattern2 periods within 2 frames, wherein P is the period of pattern1 in ms, and P₂ is the period of pattern2 in ms.

TDD-UL-DL-ConfigCommon provides the following parameters:
A reference sub-carrier spacing (SCS) μ_{ref}. This is used as a reference SCS for slots and symbols to determine the time domain boundaries in the UL-DL pattern. The network configures a value not larger than any SCS of configured BWPs of the serving cell applying the pattern(s).
Pattern1. This provides the TDD-UL-DL pattern parameters for pattern1.
Pattern2. This provides the TDD-UL-DL pattern parameters for pattern2.

Each of pattern1 and pattern2 is defined by the following parameters:
DL-UL transmission periodicity, denoted as P for pattern1 and as P₂ for pattern2. Allowed, values are {0.5, 0.625, 1, 1.25, 2, 2.5, 5, 10} ms. In one example, value 0.625 ms is only valid for μ_{ref}=3 (e.g., 120 kHz SCS). In one example, value 1.25 ms is only valid for μ_{ref}=3 and μ_{ref}=2 (e.g., 120 kHz SCS and 60 kHz respectively). In one example, value 2.5 ms is only valid for μ_{ref}=3, μ_{ref}=2 and μ_{ref}=1 (e.g., 120 kHz SCS, 60 kHz and 30 kHz respectively). A configuration period P or P₂ include S=P·2^{μ}^{_{ref}} or S₂=P₂·2^{μ}^{_{ref}} slots respectively with SCS configuration μ_{ref}. If pattern1 and pattern2 are configured, P+P₂ divides 20 ms as aforementioned.
Number of DL slots denoted as dₛₗₒₜₛ for pattern1 and as d_{slots,2} for pattern2. The first dₛₗₒₜₛ slots and the first d_{slots,2} slots for pattern1 and pattern2 respectively are DL slots with SCS configuration μ_{ref}.
Number of DL symbols denoted as d_{sym} for pattern1 and as d_{sym,2} for pattern2. The first d_{sym} symbols after the first dₛₗₒₜₛ slots and the first d_{sym,2} symbols after the first d_{slots,2} slots for pattern1 and pattern2 respectively are DL symbols with SCS configuration μ_{ref}.
Number of UL slots denoted as uₛₗₒₜₛ for pattern1 and as u_{slots,2} for pattern2. The last uₛₗₒₜₛ slots and the last u_{slots,2} slots for pattern1 and pattern2 respectively are UL slots with SCS configuration μ_{ref}.
Number of UL symbols denoted as u_{sym} for pattern1 and as u_{sym,2} for pattern2. The u_{sym} symbols before the last uₛₗₒₜₛ slots and the u_{sym,2} symbols before the last u_{slots,2} slots for pattern1 and pattern2 respectively are UL symbols with SCS configuration μ_{ref}.

FIG. 10 illustrates an example UL DL configuration 1000 according to embodiments of the present disclosure. For example, UL DL configuration 1000 can be implemented in the wireless network 100 of FIG. 1. This example is for illustration only and other embodiments can be used without departing from the scope of the present disclosure.

The remaining symbols of each pattern are flexible symbols with SCS configuration μ_{ref} For pattern1, the number of flexible symbols is

$$F = ( S - {d}_{slots} - {u}_{slots} ) {N}_{symb}^{slot} - {d}_{sym} - {u}_{sym} .$$

For pattern2 the number of flexible symbols is

$${F}_{2} = ( {S}_{2} - {d}_{slots , 2} - {u}_{slots , 2} ) {N}_{symb}^{slot} - {d}_{sym , 2} - {u}_{sym , 2} . {N}_{symb}^{slot}$$

is the number of symbols per slot. FIG. 10 illustrates an example of allocation of DL slots, DL symbols, flexible symbols, UL symbols and UL slots for pattern1.

Additionally, the UE can be configured with UE-dedicated semi-static TDD UL-DL configuration, which can override the flexible symbols of the cell-common semi-static TDD UL-DL configuration. UE-dedicated semi-static TDD UL-DL configuration provides a set of slot configurations, wherein the slots expect the reference SCS configuration μ_{ref} provided by the cell-common semi-static TDD UL-DL configuration. Each slot configuration of the set of slots configurations provides:
A slot index
A UL-DL configuration for the symbols of the slot, wherein the configuration can indicate one of: (1) symbols in the slot are DL symbols, (2) symbols in the slot are UL symbols, or (3) explicit number of DL symbols at the start of the slot and/or explicit number of UL symbols at the end of the slot, the remaining symbols in the slot are flexible symbols.

Additionally, the network can dynamically update the slot format of flexible symbols in a slot by a DCI Format (e.g., DCI Format 2_0) referred to as a slot format indicator (SFI) DCI format. The UE can be configured by higher layer IE SlotFormatIndicator, that provides:
sfi-RNTI, this is the RNTI used for SFI on a given cell, for DCI Format 2_0.
DCI payload size, this is the length of the DCI payload scrambled with SFI-RNTI.
A list of slot format combinations for the UE's serving cells. The list of slot format combinations per cell includes:
   The serving cell ID for which the slot format is applicable.
   Position in DCI Format. The starting bit position of the slot format combination ID (SFI-Index) for this serving cell within the DCI payload of the SFI DCI Format.
   A first reference sub-carrier spacing (subcarrierSpacing) and a second reference sub-carrier spacing (subcarrierSpacing2). For FDD, the first reference sub-carrier spacing applies to DL BWP, the second reference sub-carrier spacing applies to UL BWP. For TDD with supplementary UL (SUL), the first reference sub-carrier spacing applies to normal carrier, and the second reference sub-carrier spacing applies to SUL carrier.
   A list of slot format combinations, wherein the slot format combinations doesn't exceed 512. Each slot format combination includes:
      A slot format combination ID, this is the ID used in the payload of SFI DCI Format (DCI Format 2_0).
      A number of slots formats from Table 11.1.1-1 of [REF 3]. The slot formats occur in consecutive slots, based on subcarrierSpacing or subcarrierSpacing2 as aforementioned, starting from the slot with the SFI DCI Format.

DL signals include data signals conveying information content, control signals conveying DL control information (DCI), and reference signals (RS) that are also known as pilot signals. A gNB (e.g., the BS 102) transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format. A DCI format scheduling PDSCH reception or PUSCH transmission for a single UE, such as a DCI format with CRC scrambled by C-RNTI/CS-RNTI/MCS-C-RNTI as described in [REF 2], are referred for brevity as a unicast DCI format. A DCI format scheduling PDSCH reception for multicast communication, such as a DCI format with CRC scrambled by G-RNTI/G-CS-RNTI as described in [REF 2], are referred to as multicast DCI format. DCI formats providing various control information to at least a subset of UEs in a serving cell, such as DCI format 2_0 in [REF 2], are referred to as group-common (GC) DCI formats.

The downlink physical-layer processing of transport channels on PDSCH can include the following steps: (1) Transport block CRC attachment; (2) Code block segmentation and code block CRC attachment; (3) Channel coding: LDPC coding; (4) Physical-layer hybrid-ARQ processing; (5) Rate matching; (6) Scrambling; (7) Modulation: QPSK, 16QAM, 64QAM, 256QAM, and 1024QAM; (8) Layer mapping; and (9) Mapping to assigned resources and antenna ports.

As aforementioned, the Physical Downlink Control Channel (PDCCH) can be used to schedule DL transmissions on PDSCH and UL transmissions on PUSCH, where the Downlink Control Information (DCI) on PDCCH includes: (1) Downlink assignments containing at least modulation and coding format, resource allocation, and hybrid-ARQ information related to DL-SCH; and (2) Uplink scheduling grants containing at least modulation and coding format, resource allocation, and hybrid-ARQ information related to UL-SCH. In addition to scheduling, PDCCH can be used to for: (1) Activation and deactivation of configured PUSCH transmission with configured grant; (2) Activation and deactivation of PDSCH semi-persistent transmission; (3) Notifying one or more UEs of the slot format; (4) Notifying one or more UEs of the RB(s) and OFDM symbol(s) where the UE may expect no transmission is intended for the UE; (5) Transmission of TPC commands for PUCCH and PUSCH; (6) Transmission of one or more TPC commands for SRS transmissions by one or more UEs; (7) Switching a UE's active bandwidth part; (8) Initiating a random access procedure; (9) Indicating the UE(s) to monitor the PDCCH during the next occurrence of the DRX on-duration; (10) In integrated access and backhaul (IAB) context, indicating the availability for soft symbols of an IAB-DU; (11) Triggering one shot HARQ-ACK codebook feedback; and (11) For operation with shared spectrum channel access: (11a) Triggering search space set group switching; (11b) Indicating one or more UEs about the available RB sets and channel occupancy time duration; and (11c) Indicating downlink feedback information for configured grant PUSCH (CG-DFI). Polar coding is used for PDCCH. QPSK modulation is used for PDCCH.

A UE monitors a set of PDCCH candidates in the configured monitoring occasions in one or more configured COntrol REsource SETs (CORESETs) according to the corresponding search space configurations.

A gNB (such as BS 102) transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IRs), CSI interference measurement (CSI-IM) resources associated with a zero power CSI-RS (ZP CSI-RS) configuration are used. A CSI process includes NZP CSI-RS and CSI-IM resources. A UE (such as UE 116) can determine CSI-RS transmission parameters through DL control signaling or higher layer signaling, such as radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, link recovery request (LRR) for beam failure recovery, CSI reports enabling a gNB to select appropriate parameters for PDSCH or PDCCH transmissions to a UE, and UE initiated resource indicator (UEI-RI) indicating a request to transmit a UE initiated measurement report. HARQ-ACK information can be configured to be with a smaller granularity than per TB and can be per data code block (CB) or per group of data CBs where a data TB includes a number of data.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH).

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may expect the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may expect that synchronization signal (SS)/PBCH block (also denoted as SSBs) transmitted with the same block index on the same center frequency location are quasi co-located with respect to Doppler spread, Doppler shift, average gain, average delay, delay spread, and, when applicable, spatial Rx parameters. The UE may not expect quasi co-location for any other synchronization signal SS/PBCH block transmissions.

In absence of CSI-RS configuration, and unless otherwise configured, the UE may expect PDSCH DM-RS and SSB to be quasi co-located with respect to Doppler shift, Doppler spread, average delay, delay spread, and, when applicable, spatial Rx parameters. The UE may expect that the PDSCH DM-RS within the same code division multiplexing (CDM) group is quasi co-located with respect to Doppler shift, Doppler spread, average delay, delay spread, and spatial Rx. The UE may also expect that DM-RS ports associated with a PDSCH are QCL with QCL type A, type D (when applicable) and average gain. The UE may further expect that no DM-RS collides with the SS/PBCH block.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

The quasi-co-location relationship is configured by the higher layer parameter qcl-Type1 for the first DL RS, and qcl-Type2 for the second DL RS (if configured). For the case of two DL RSs, the QCL types may not be the same, regardless of whether the references are to the same DL RS or different DL RSs. The quasi-co-location types corresponding to each DL RS are given by the higher layer parameter qcl-Type in QCL-Info and may take one of the following values: QCL-TypeA: {Doppler shift, Doppler spread, average delay, delay spread}; QCL-TypeB: {Doppler shift, Doppler spread}; QCL-TypeC: {Doppler shift, average delay}; and QCL-TypeD: {Spatial Rx parameter}.

The UE (e.g., the UE 116) receives a MAC-CE activation command to map up to [N] (e.g., N=8) TCI states to the codepoints of the DCI field “Transmission Configuration Indication.” When the HARQ-ACK corresponding to the PDSCH carrying the activation command is transmitted in slot n, the indicated mapping between TCI states and codepoints of the DCI field “Transmission Configuration Indication” may be applied after a MAC-CE application time, e.g., starting from the first slot that is after slot

$$( n + 3 {N}_{slot}^{subframe , μ} ) .$$

In this disclosure, a beam can be determined by any of,
A TCI state, that establishes a quasi-colocation (QCL) relationship or spatial relation between a source reference signal (e.g. SSB and/or CSI-RS) and a target reference signal
A spatial relation information that establishes an association to a source reference signal, such as SSB or CSI-RS or SRS.

In either case, the ID of the source reference signal or TCI state or spatial relation identifies the beam.

The TCI state and/or the spatial relation reference RS can determine a spatial Rx filter for reception of downlink channels at the UE, or a spatial Tx filter for transmission of uplink channels from the UE. The TCI state and/or the spatial relation reference RS can determine a spatial Tx filter for transmission of downlink channels from the gNB, or a spatial Rx filter for reception of uplink channels at the gNB.

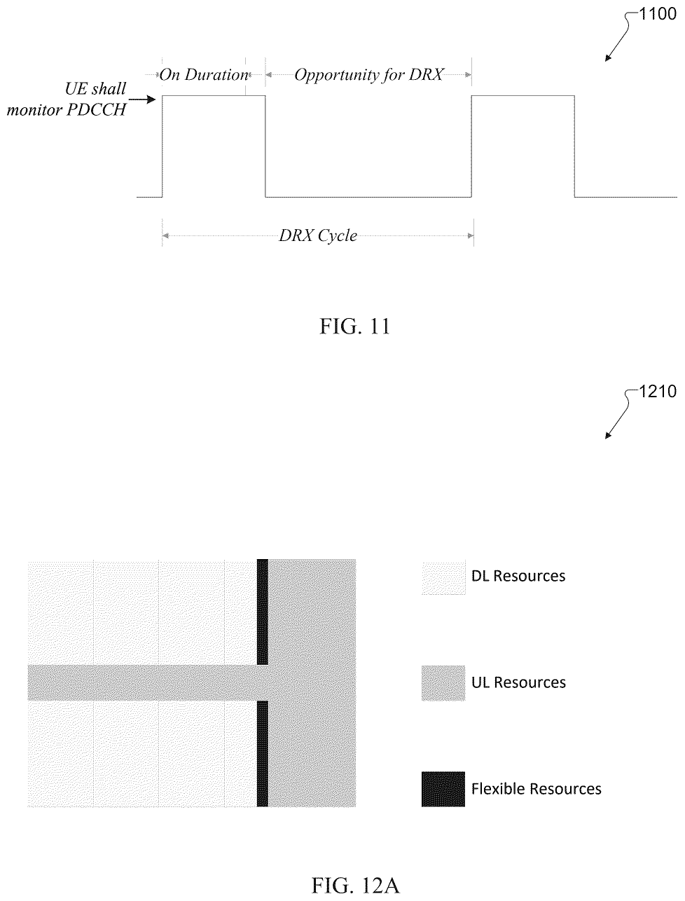

FIG. 11 illustrates an example DRX 1100 according to embodiments of the present disclosure. For example, DRX 1100 can be implemented in any of the UEs 111-116 of FIG. 1, such as the UE 112. This example is for illustration only and other embodiments can be used without departing from the scope of the present disclosure.

In NR, the blind decoding of PDCCH in each monitoring occasion can increase the UE's power consumption. To mitigate the increase, in UE's power consumption, NR introduced UE power saving mechanisms, whereby the PDCCH monitoring activity of the UE in RRC connected mode is governed by DRX, BA (bandwidth adaptation), DCP (DCI with CRC scrambled by power saving RNTI (PS-RNTI)) and cell discontinuous transmission (DTX).

When DRX is configured, the UE does not have to continuously monitor PDCCH. DRX is characterized by the following:
on-duration: duration that the UE waits for, after waking up, to receive PDCCHs. If the UE successfully decodes a PDCCH, the UE stays awake and starts the inactivity timer.
inactivity-timer: duration that the UE waits to successfully decode a PDCCH, from the last successful decoding of a PDCCH, failing which it can go back to sleep. The UE shall restart the inactivity timer following a single successful decoding of a PDCCH for a first transmission only (i.e. not for retransmissions).
retransmission-timer: duration until a retransmission can be expected.
cycle: specifies the periodic repetition of the on-duration followed by a period of inactivity. This is illustrated in FIG. 11.
active-time: total duration that the UE monitors PDCCH. This includes the “on-duration” of the DRX cycle, the time UE is performing continuous reception while the inactivity timer has not expired, and the time when the UE is performing continuous reception while waiting for a retransmission opportunity.

When BA is configured, the UE only has to monitor PDCCH on the one active BWP i.e. it does not have to monitor PDCCH on the entire DL frequency of the cell. A BWP inactivity timer (independent from the DRX inactivity-timer described herein) is used to switch the active BWP to the default one: the timer is restarted upon successful PDCCH decoding and the switch to the default BWP takes place when it expires.

In addition, the UE may be indicated, when configured accordingly, whether it is required to monitor or not the PDCCH during the next occurrence of the on-duration by a DCP monitored on the active BWP. If the UE does not detect a DCP on the active BWP, it does not monitor the PDCCH during the next occurrence of the on-duration, unless it is explicitly configured to do so in that case. DCP is a DCI Format (DCI Format 2_6) with CRC scrambled by PS-RNTI which is used to determine if the UE needs to monitor PDCCH on the next occurrence of the connected mode DRX on-duration. One DCP can be configured to control PDCCH monitoring during on-duration for one or more UEs independently. A UE is allocated a block of bits in DCI Format 2_6, with one bit for wake-up indication, and up to 5 bits for SCell dormancy indication.

A UE can only be configured to monitor DCP when connected mode DRX is configured, and at occasion(s) at a configured offset before the on-duration. More than one monitoring occasion can be configured before the on-duration. The UE does not monitor DCP on occasions occurring during active-time, measurement gaps, BWP switching, or when it monitors response for a contention-free random access (CFRA) preamble transmission for beam failure recovery, in which case it monitors the PDCCH during the next on-duration. If no DCP is configured in the active BWP, UE follows normal DRX operation.

When CA is configured, DCP is only configured on the PCell.

Power saving in RRC_IDLE and RRC_INACTIVE can also be achieved by UE relaxing neighbor cells RRM measurements when it meets the criteria determining it is in low mobility and/or not at cell edge. When UE is configured with both high speed measurements and RRM measurement relaxation as specified in [REF 6], it is up to UE implementation whether to apply the FR1 high speed RRM requirements or the relaxed RRM requirements when the low mobility related criterion is configured and fulfilled as specified in TS 38.133.

UE power saving may be enabled by adapting the DL maximum number of MIMO layers by BWP switching.

Power saving is also enabled during active-time via cross-slot scheduling, which facilitates UE to achieve power saving with the assumption that it won't be scheduled to receive PDSCH, triggered to receive A-CSI or transmit a PUSCH scheduled by the PDCCH until the minimum scheduling offsets K0 and K2. Dynamic adaptation of the minimum scheduling offsets K0 and K2 is controlled by PDCCH.

Serving Cells of a MAC entity may be configured by RRC in two DRX groups with separate DRX parameters. When RRC does not configure a secondary DRX group, there is only one DRX group and Serving Cells belong to that one DRX group. When two DRX groups are configured, each Serving Cell is uniquely assigned to either of the two groups. The DRX parameters that are separately configured for each DRX group are on-duration and inactivity-timer.

UE power saving in RRC_IDLE/RRC_INACTIVE may be achieved by providing the configuration for tracking reference signal (TRS) with CSI-RS for tracking in TRS occasions. The TRS in TRS occasions may allow UEs in RRC_IDLE/RRC_INACTIVE to sleep longer before waking-up for its paging occasion. The TRS occasions configuration is provided in either SIB17 or SIB17bis. The availability of TRS in the TRS occasions is indicated by L1 availability indication. These TRSs may also be used by the UEs configured with eDRX.

UE power saving may be achieved by UE relaxing measurements for radio link monitoring (RLM)/beam failure detection (BFD). When configured, UE determines whether it is in low mobility state and/or whether its serving cell radio link quality is better than a threshold. The configuration for low mobility and good serving cell quality criterion is provided through dedicated RRC signalling.

RLM and BFD relaxation may be enabled/disabled separately through RRC Configuration. Additionally, RLM relaxation may be enabled/disabled on per Cell Group basis while BFD relaxation may be enabled/disabled on per serving cell basis.

The UE is only allowed to perform RLM and/or BFD relaxation when relaxed measurement criterion for low mobility and/or for good serving cell quality is met. If configured to do so, the UE shall trigger reporting of its RLM and/or BFD relaxation status through UE assistance information if the UE changes its respective RLM and/or BFD relaxation status while meeting the UE minimum requirements specified in TS 38.133.

UE power saving may also be achieved through PDCCH monitoring adaptation mechanisms when configured by the network, including skipping of PDCCH monitoring and Search space set group (SSSG) switching. In this case UE does not monitor PDCCH during the PDCCH skipping duration except for the cases as specified in [REF 3], or monitors PDCCH according to the search space sets applied in SSSG.

In order to reduce UE power consumption due to false paging alarms, the group of UEs monitoring the same PO can be further divided into multiple subgroups. With subgrouping, a UE shall monitor PDCCH in its PO for paging if the subgroup to which the UE belongs is paged as indicated via associated PEI (Paging Early Indication). If a UE cannot find its subgroup ID with the PEI configurations in a cell or if the UE is unable to monitor the associated PEI occasion corresponding to its PO, it shall monitor the paging in its PO. A PEI is a DCI Format (DCI Format 27) with CRC scrambled by PEI-RNTI used to determine if the UE needs to monitor the associated PO.

The UE can signal the network (e.g., the network 130) through UEAssistanceInformation if it prefers certain DRX parameter values, and/or a reduced maximum number of secondary component carriers, and/or a reduced maximum aggregated bandwidth and/or a reduced maximum number of MIMO layers and/or minimum scheduling offsets K0 and K2 for power saving purpose.

Next generation wireless systems are expected to support a wide range of usage scenarios that expand on the NR usage scenarios such as immersive communication (IC), hyper reliable and low-latency communication (HRLLC), massive communications, artificial intelligence (AI) and communication, ubiquitous connectivity and integrated sensing and communication (ISAC). These usage scenarios have common design principles and overarching aspects such as sustainability, connecting the unconnected, ubiquitous intelligence and security and resilience. New spectrum in the upper mid-band (7-24 GHz) is expected to leverage ultra-massive MIMO architectures with large number of antenna ports (e.g., 256) and large number of MIMO layers (e.g., 64) to meet coverage and capacity requirements.

To meet these goals, a new design paradigm is envisioned, that is centered on the users' needs (e.g., for communication or sensing) and the desire to cater to such needs in a spectrally efficient and power efficient manner. Depending on the scenario, sensing requirements, channel and traffic conditions, the air interface can be used for downlink-heavy traffic, uplink-heavy traffic, device-to-device (sidelink) heavy traffic, sensing, a mixture of this, or, at quiet times, no traffic. Transmissions on the air interface can be user initiated, or can be scheduled and allocated by centralized scheduler or a mix of the two. To meet these, the air interface is expected to be adaptable based on the situation.

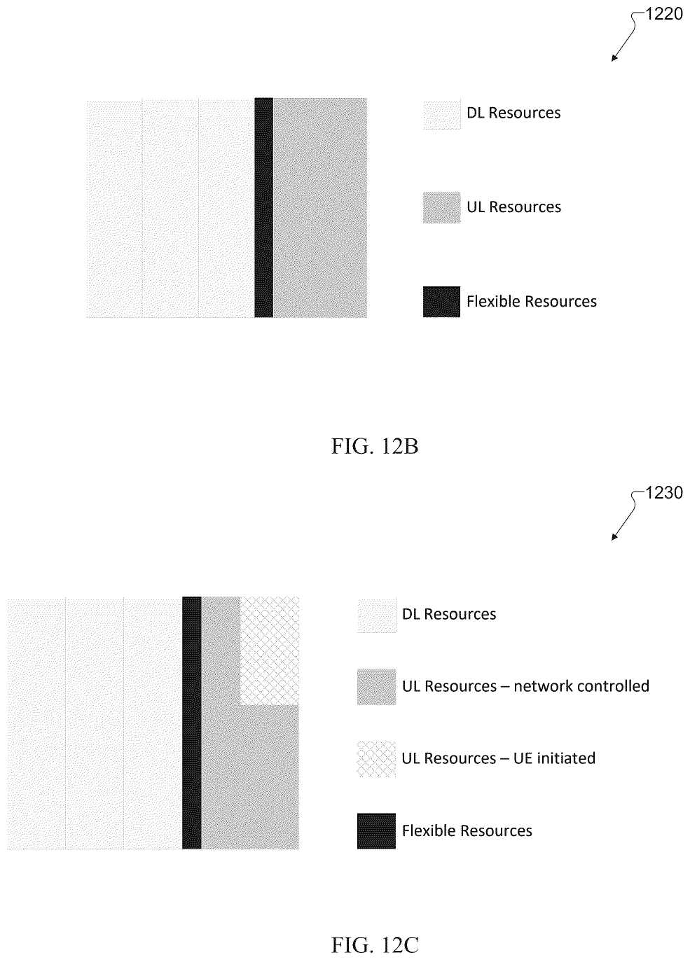

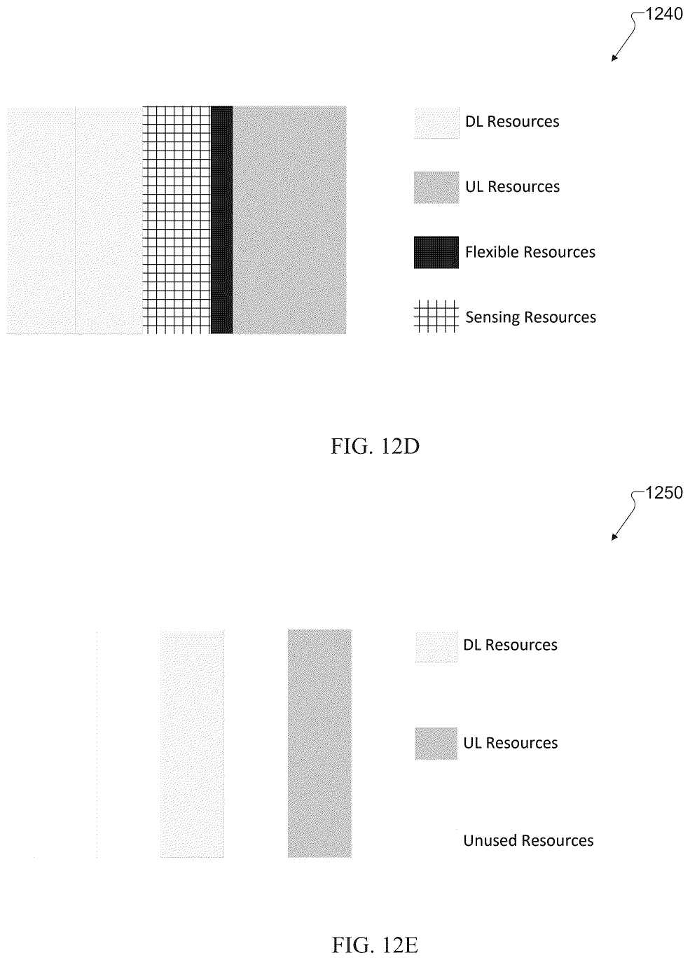

FIGS. 12A, 12B, 12C, 12D, and 12E illustrate an example resource configuration 1210, 1220, 1230, 1240, and 1250, respectively, according to embodiments of the present disclosure. For example, resource configuration 1210, 1220, 1230, 1240, and 1250, respectively, can be configured by the BS 102 of FIG. 1. This example is for illustration only and other embodiments can be used without departing from the scope of the present disclosure.

Different type of resources can be configured and allocated depending on the current needs of the wireless system. For example, in times of heavy downlink traffic, with coverage limited UEs, more resources are allocated DL, but with sufficient UL resources in time domain to guaranty coverage for coverage limited UEs, in this case SBFD can be used as illustrated in FIG. 12(A). In another example, in case of moderate downlink and uplink traffic, and without coverage limited UEs resources can be split between DL and UL based on the traffic split as illustrated in FIG. 12(B). In another example, for massive communications, with multiple sensors or IoT devices that can autonomously transmit UE initiated traffic, part of the spectrum can be allocated to UE initiated traffic as illustrated in FIG. 12(C). In another example, when need arises to sense the environment, for example for smart traffic, resources can be allocated to sensing as illustrated in FIG. 12(D). Finally, at night as traffic volume drops, some resources can be left unused, leaving the remaining resources for the low traffic volume as illustrated in FIG. 12(E), for network energy savings and low UE power consumption.

The air interface is viewed as a pipe, and how the pipe is used is adapted to the current conditions. To achieve this type of air interface adaptability, the network can send a message periodically or on demand to indicate to the UEs in the vicinity how the interface is allocated or configured in the next time interval. The adaptability can be done in a common manner for UEs in a cell, or can be done to a group of UEs, or to one UE.

In this disclosure, the design of such signaling mechanism is provided, and the information it conveys.

The present disclosure relates to a 5G/NR and/or 6G communication system.

This disclosure provides signaling for adapting the air interface
Signaling can be transmitted periodically, or on demand.
Signaling conveying configuration information for adaptability can be sent to UEs in a cell, to a group of UEs or to a specific UE depending on the scope of the configuration information.
Content of configuration information for adaptability.

In the following, both FDD and TDD are regarded as a duplex method for DL and UL signaling. In addition, full duplex (XDD) operation is provided, e.g., sub-band full duplex (SBFD) or single frequency full duplex (SFFD).

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure provides several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based signaling (e.g., SIB1 or other SIB) or (2) RRC dedicated signaling that is sent to a specific UE wherein the information can be common/cell-specific information or dedicated/UE-specific information or (3) UE-group-common RRC signaling.

In this disclosure MAC CE signaling can be UE-specific e.g., to one UE or can be UE common (e.g., to a group of UEs or to UEs in a cell). MAC CE signaling can be DL MAC CE signaling or UL MAC CE signaling.

In this disclosure L1 control signaling includes: (1) DL control information (e.g., DCI on PDCCH or DL control information on PDSCH) and/or (2) UL control information (e.g., UCI on PUCCH or PUSCH). L1 control signaling can be UE-specific e.g., to one UE, or can be UE common e.g., to a group of UEs or UEs in cell.

In this disclosure a list with N elements can be denoted as L(i), where i can take N values, and L(i) can correspond to the element or entry associated with index i. In one example, i can take N arbitrary values. In one example, i=0, 1, . . . , N−1. In one example, i=1, 2, . . . , N. In one example, i is an identity of an element or entry in the list.

In the present disclosure, the term “activation” describes an operation wherein a UE receives and decodes first information provided by a first signal from the network (or gNB) and, based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or gNB) and, based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group or RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

Terminology such as search space, search space set, control resource set (CORESET), DCI Format, uplink control information (UCI), HARQ-ACK, SBFD and other terms, is used for illustrative purposes and is therefore not normative. Other terms that refer to same functions can also be used.

In this disclosure configuration information refers to information transmitted by the network that controls the configuration of the air interface resources, for example, which resources are used for DL traffic or UL traffic or SL traffic (e.g., if not provided as part of the UL traffic), or sensing, or unused resources (e.g., for energy savings). Configuration information could also provide information about full duplex (FD) configuration, e.g., DL sub-band(s) or UL sub-band(s) in a FD symbol or slot. Configuration information, can also indicate resources where UE(s) can initiate transmissions, e.g., on the UL interface or SL interface. Configuration information, can also indicate the configuration of synchronization signal/physical broadcast channel (SS/PBCH) blocks (SSBs).

Later in this disclosure, examples of configuration information are provided. Configuration information can include configuration for channels or signals, wherein the channels or signals can be common channels or signals or UE-group common channels or signals or UE-specific channels or signals.

In one example, the channel conveying the configuration information is transmitted to UEs in the cell, e.g., the configuration information is relevant to UEs in a cell and is transmitted using a cell-specific channel.

In one example, the channel conveying the configuration information is transmitted to a group of UEs, e.g., the configuration information is relevant to a group of UEs and is transmitted using a UE group specific channel.

In one example, the channel conveying the configuration information is transmitted to a UE, e.g., the configuration information is relevant to a UE and is transmitted using a UE-specific channel.

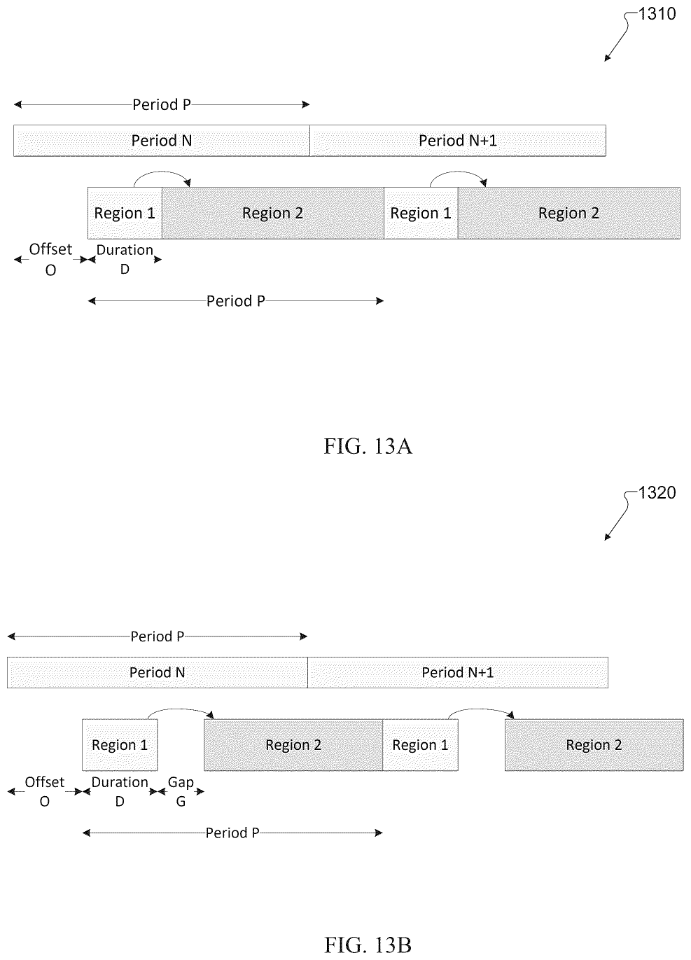

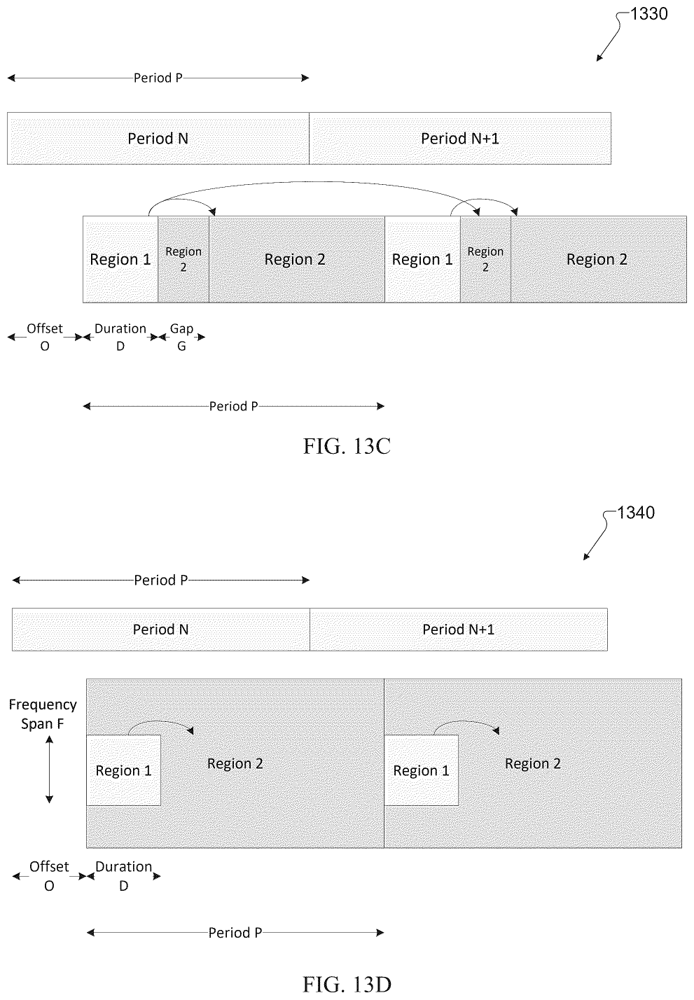

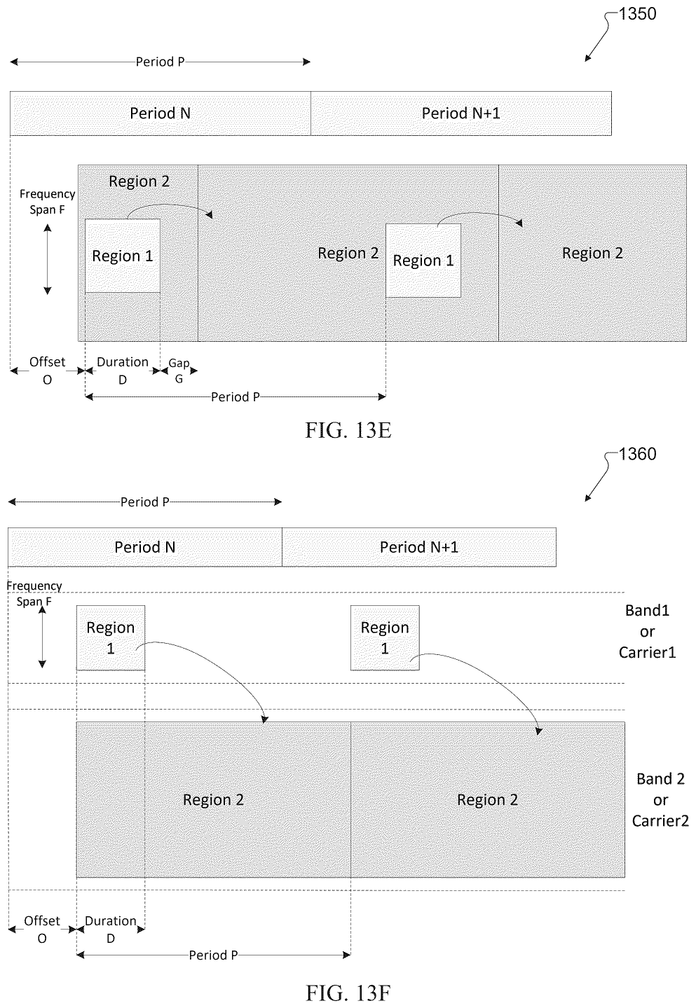

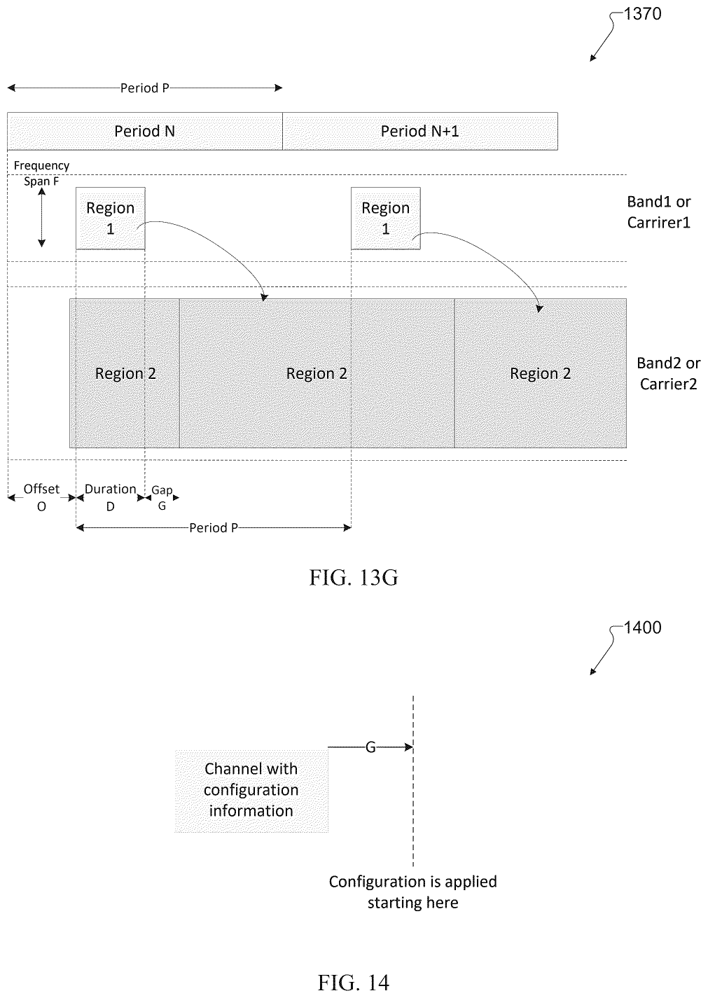

FIGS. 13A, 13B, 13C, 13D, 13E, 13F, and 13G illustrate example of signaling configuration information 1310, 1320, 1330, 1340, 1350, 1360, and 1370, respectively, according to embodiments of the present disclosure. For example, configuration information 1310, 1320, 1330, 1340, 1350, 1360, and 1370, respectively, can be received by any of the UEs 111-116 of FIG. 1, such as the UE 113. This example is for illustration only and other embodiments can be used without departing from the scope of the present disclosure.

In one example, the configuration information is transmitted periodically as illustrated in FIGS. 13A-13G. In FIGS. 13A-13G, the air interface resources are partitioned into two regions. A first region (e.g., region 1), is where configuration information about a second region (e.g., region 2) is provided. In one example, region 1 repeats with a period P, wherein P can be in time-units or symbols or slots or sub-frames or frames or units of time (e.g., seconds or milli-seconds). In one example, Region 1 has an offset of 0 (e.g., from start of system frame number (SFN) #0), wherein 0 can be in time-units or symbols or slots or sub-frames or frames or units of time (e.g., seconds or milli-seconds). In one example the start of a period (e.g., period 0) is the start of system frame number (SFN) 0, e.g., at the start of the first symbol or first slot or first sub-frame of SFN 0. In one example, region 1 has a duration D, wherein P can be in time-units or symbols or slots or sub-frames or units of time (e.g., seconds or milli-seconds).

In one example, the configuration information provided in region 1 is for a region 2 that starts right after region 1 as illustrated in FIG. 13(A). In one example, the signal in region 1 can include one or more channels conveying cell-common configuration information. In one example, the signal in region 1 can include one or more channels conveying UE-group configuration information. In one example, the signal in region 1 can include one or more channels conveying UE-specific configuration information. In one example, the signal in region 1 can include signals for synchronization (e.g., SS/PBCH blocks). In one example, the signal in region 1 can include common channels (e.g., SIB1).

In one example, the configuration information provided in region 1 is for region 2, where there is a gap, G, between the end region 1 and the start of region 2, wherein G can be in time-units or symbols or slots or sub-frames or frames or units of time (e.g., seconds or milli-seconds). This is illustrated in FIG. 13(B). In one example, the signal in region 1 can include one or more channels conveying cell-common configuration information. In one example, the signal in region 1 can include one or more channels conveying UE-group configuration information. In one example, the signal in region 1 can include one or more channels conveying UE-specific configuration information. In one example, the signal in region 1 can include signals for synchronization (e.g., SS/PBCH blocks). In one example, the signal in region 1 can include common channels (e.g., SIB1).

In one example, the configuration information provided in region 1 is for region 2, where there is a gap, G, between the end region 1 and the start of region 2, wherein G can be in time-units or symbols or slots or sub-frames or frames or units of time (e.g., seconds or milli-seconds). The gap G between the end of region 1 and the start of its corresponding region 2 is used by (of follows the configuration of) the previous region 2. This is illustrated in FIG. 13(C). In one example, the signal in region 1 can include one or more channels conveying cell-common configuration information. In one example, the signal in region 1 can include one or more channels conveying UE-group configuration information. In one example, the signal in region 1 can include one or more channels conveying UE-specific configuration information. In one example, the signal in region 1 can include signals for synchronization (e.g., SS/PBCH blocks). In one example, the signal in region 1 can include common channels (e.g., SIB1).

In one example, the span of region 1 in the frequency domain is F, wherein F can be in frequency-units, or sub-carriers, or resource blocks (RBs) or sub-channels (e.g., a group of RBs). In one example, the start of region 1 can align with the start of region 2 in the frequency domain. In one example, the end of region 1 can align with the end of region 2 in the frequency domain. In one example, neither the start nor the end of region 1 aligns with the start or end of region 2 as illustrated in FIG. 13(D) and FIG. 13(E). In one example, the start of region 1, in time domain, aligns with the start of the corresponding region 2, as illustrated in FIG. 13(D). In one example, the end of region 1, in time domain, aligns with the start of the corresponding region 2. In one example, there is gap G, in time domain, between the end of region 1 and the start of the corresponding region 2, wherein the previous region 2 continues till the start of the current region 2, as illustrated in FIG. 13(E), wherein G can be in time-units or symbols or slots or sub-frames or frames or units of time (e.g., seconds or milli-seconds). In a variant example, region 2 of the previous period can end, in time domain, before the start or the end of the region 1 of the current period. In one example, the signal in region 1 can include one or more channels conveying cell-common configuration information. In one example, the signal in region 1 can include one or more channels conveying UE-group configuration information. In one example, the signal in region 1 can include one or more channels conveying UE-specific configuration information. In one example, the signal in region 1 can include signals for synchronization (e.g., SS/PBCH blocks). In one example, the signal in region 1 can include common channels (e.g., SIB1).

In one example, region 1 is transmitted in a first band or carrier and the corresponding region 2 is in a second band or carrier as illustrated in FIG. 13(F) and FIG. 13(G). In one example, the span of region 1 in the frequency domain is F, wherein F can be in frequency-units, or sub-carriers, or resource blocks (RBs) or sub-channels (e.g., a group of RBs). In one example, the start of region 1, in time domain, aligns with the start of the corresponding region 2, as illustrated in FIG. 13(F). In one example, the end of region 1, in time domain, aligns with the start of the corresponding region 2. In one example, there is gap G, in time domain, between the end of region 1 and the start of the corresponding region 2, wherein the previous region 2 continues till the start of the current region 2, as illustrated in FIG. 13(G), wherein G can be in time-units or symbols or slots or sub-frames or frames or units of time (e.g., seconds or milli-seconds). In a variant example, region 2 of the previous period can end, in time domain, before the start or the end of the region 1 of the current period. In one example, the signal in region 1 can include one or more channels conveying cell-common configuration information. In one example, the signal in region 1 can include one or more channels conveying UE-group configuration information. In one example, the signal in region 1 can include one or more channels conveying UE-specific configuration information. In one example, the signal in region 1 can include signals for synchronization (e.g., SS/PBCH blocks). In one example, the signal in region 1 can include common channels (e.g., SIB1).

In the aforementioned example, P, O, D, G and F (in the figures) can be specified in the system specifications and/or configured or updated by SIB or RRC or MAC CE or L1 control (e.g., DCI Format) signaling.

In one example, configuration transmitted in an instance of region 1, can adjust the periodicity and occurrence of future instances of region 1. In one example, one or more future instances of region 1 can be skipped. In one example, the period P of region 1 can be adjusted.

In one example of the aforementioned examples, region 1 is where the channel(s) conveying configuration interval can be sent to update the configuration information of the corresponding region 2. In one example, if no channel conveying configuration information is received in region 1, the configuration of the corresponding region 2 instance remains unchanged from the previous instance of region 2. In one example, if no channel conveying configuration information is received in region 1, a default configuration, as described later in this disclosure, is applied to the corresponding region 2 instance. In one example, if there is no change in configuration information, a channel or signal is transmitted in region 1 to indicate that there is no change in configuration information for the corresponding instance of region 2.

In one example, as described later in this disclosure:
multiple configurations and associated indices are configured by RRC and/or SIB signaling
Signaling in region 1 (e.g., L1 control signaling (e.g., DCI Format) or MAC CE/RRC/ASN.1 signaling) can be used to indicate one or more indices for configuration to apply in the corresponding region 2.

FIG. 14 illustrates an example of signaling and application timing of configuration information 1400 according to embodiments of the present disclosure. For example, configuration information 1400 can be received by any of the UEs 111-116 of FIG. 1, such as the UE 114. This example is for illustration only and other embodiments can be used without departing from the scope of the present disclosure.

In one example, the configuration information is transmitted by the network, when there is a change in configuration information. In one example, the configuration indicated by the channel and is applied after a gap G from the channel conveying the configuration information. In one example, G can be in time-units and/or symbols and/or slots and/or sub-frames and/or frames. In one example, G is from the end of the channel as illustrated in FIG. 14. In one example, G is from the start of the channel. In one example, the new configuration is applied at the start of the first time-unit or symbol or slot or sub-frame or frame that starts after a gap G from the end or start of the channel conveying the configuration information or from the end or start of the time-unit or slot or sub-frame that contains the channel conveying the configuration information. In one example, the time-unit or symbol or slot is determined by the sub-carrier spacing (SCS) of the carrier or BWP to which the configuration applies. In one example, the time-unit or symbol or slot is determined by the smallest SCS of the carrier(s) and/or BWP(s) to which the configuration applies. In one example, the time-unit or symbol or slot is determined by the largest SCS of the carrier(s) and/or BWP(s) to which the configuration applies. In one example, the time-unit or symbol or slot is determined by the SCS of the channel conveying the configuration information. In one example, the time-unit or symbol or slot is determined by the smallest SCS of the channel conveying the configuration information and of the carrier(s) or BWP(s) to which the configuration applies. In one example, the time-unit or symbol or slot is determined by the largest SCS of the channel conveying the configuration information and of the carrier(s) or BWP(s) to which the configuration applies.

In one example, the channel with configuration information is in a first carrier or band, and the configuration information is applied to a second carrier or band.

In one example, the channel with configuration information includes cell-common configuration information. In one example, the channel with configuration information is to UEs in a cell. In one example, the channel with configuration information includes UE-group-common configuration information. In one example, the channel with configuration information is to a UE group (group of UEs). In one example, the channel with configuration information includes UE-specific configuration information. In one example, the channel with configuration information is to a UE.

In one example, in the aforementioned examples, G can be a single value. In one example, in the aforementioned examples, G can be within a range between G₁ and G₂.

In the aforementioned examples, G and/or G₁ and/or G₂ can be specified in the system specifications and/or configured or updated by SIB or RRC or MAC CE or L1 control (e.g., DCI Format) signaling. In one example, G and/or G₁ and/or G₂ is determined by the SCS of the carrier or BWP to which the configuration applies. In one example, G and/or G₁ and/or G₂ is determined by the smallest SCS of the carrier(s) and/or BWP(s) to which the configuration applies. In one example, G and/or G₁ and/or G₂ is determined by the largest SCS of the carrier(s) and/or BWP(s) to which the configuration applies. In one example, G and/or G₁ and/or G₂ is determined by the SCS of the channel conveying the configuration information. In one example, G and/or G₁ and/or G₂ is determined by the smallest SCS of the channel conveying the configuration information and of the carrier(s) or BWP(s) to which the configuration applies. In one example, G and/or G₁ and/or G₂ is determined by the largest SCS of the channel conveying the configuration information and of the carrier(s) or BWP(s) to which the configuration applies.

In one example, the channel with configuration information is a physical layer downlink control channel (e.g., PDCCH). In one example, the PDCCH is transmitted in a CORESET. In one example, the PDCCH is transmitted in a search space. In one example, the search space is a common search space.

In one example, the channel with configuration information is a physical layer downlink shared channel (e.g., PDSCH). In one example, the PDSCH is scheduled (e.g., scheduling determines resources and/or payload size and code rate) by a PDCCH. In one example, the PDCCH is transmitted in a CORESET. In one example, the PDCCH is transmitted in a search space. In one example, the search space is a common search space. In one example, the configuration information is included in downlink control information (DCI) in PDSCH. In one example, the configuration information is included in a MAC CE in PDSCH. In one example, the configuration information is included in a ASN.1 message or RRC message in PDSCH.

In one example, the payload size and/or modulation scheme and/or code rate for the channel conveying the configuration information is configured or update SIB or RRC or MAC CE or L1 control signaling.

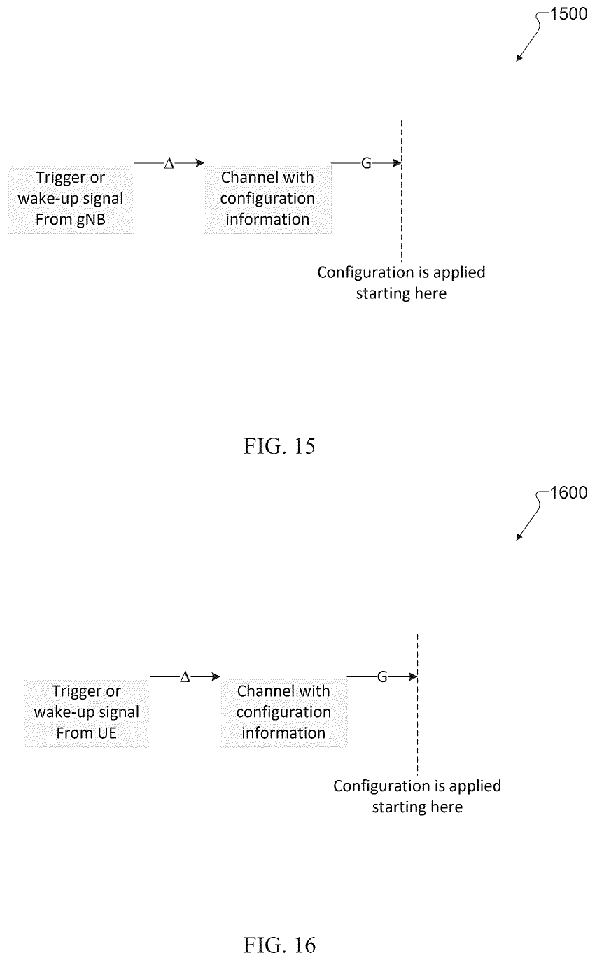

FIG. 15 illustrates an example of gNB triggering 1500 and application of configuration information according to embodiments of the present disclosure. For example, trigger 1500 can be received by any of the UEs 111-116 of FIG. 1, such as the UE 115. This example is for illustration only and other embodiments can be used without departing from the scope of the present disclosure.

In one example, before transmitting the channel configuration information, the network (e.g., the network 130) transmits a trigger signal or a wake-up-signal (WUS) as illustrated in FIG. 15. In one example, the WUS is a signal received by a low-power receiver, after the UE receives the WUS by a low-power radio, the UE wakes up the main radio to receive the channel with configuration information. In one example, the WUS is a sequence-based signal. In one example, the channel with configuration information is transmitted after a gap Δ from the trigger or wake-up signal. In one example, Δ can be in time-units and/or symbols and/or slots and/or sub-frames and/or frames. In one example, Δ is from the end of the trigger/WUS to the start of the channel conveying configuration information as illustrated in FIG. 15. In one example, Δ is from the start of the trigger/WUS to the start of the channel conveying configuration information. In one example, Δ is from the end of the trigger/WUS to the end of the channel conveying configuration information. In one example, Δ is from the start of the trigger/WUS to the end of the channel conveying configuration information. In one example, the channel conveying the configuration information is transmitted in a first time-unit or slot or sub-frame or frame that starts after a gap Δ from the end or start of the trigger/WUS or from the end or start of the time-unit or slot or sub-frame that contains the trigger/WUS.

In one example, the time-unit or slot is determined by a sub-carrier spacing (SCS) of the trigger/WUS or channel conveying configuration or the carrier(s) or BWP(s) to which the configuration applies. In one example, the time-unit or slot is determined by the smallest sub-carrier spacing (SCS) of the trigger/WUS and/or channel conveying configuration and/or the carrier(s) and/or BWP(s) to which the configuration applies. In one example, the time-unit or slot is determined by the largest sub-carrier spacing (SCS) of the trigger/WUS and/or channel conveying configuration and/or the carrier(s) and/or BWP(s) to which the configuration applies.

In one example, the trigger/WUS is in a first carrier or band or BWP, the channel with configuration information is in a second carrier or band or BWP, and the configuration information is applied to a third carrier or band or BWP. In one example, the first and the second carrier/band/BWP are the same carrier/band/BWP. In one example, the first and the third carrier/band/BWP are the same carrier/band/BWP. In one example, the second and the third carrier/band/BWP are the same carrier/band/BWP. In one example, the first and the second and the third carrier/band/BWP are the same carrier/band/BWP.

In one example, the channel with configuration information includes cell-common configuration information. In one example, the channel with configuration information is to UEs in a cell. In one example, the WUS is sent to UEs in a cell. In one example, the channel with configuration information includes UE-group-common configuration information. In one example, the channel with configuration information is to a UE group (group of UEs). In one example, the WUS is sent to a UE group (group of UEs). In one example, the channel with configuration information includes UE-specific configuration information. In one example, the channel with configuration information is to a UE. In one example, the WUS is sent to a UE.

In one example, in the aforementioned examples, Δ can be a single value. In one example, in the aforementioned examples, Δ can be within a range between Δ₁ and Δ₂.

In the aforementioned examples, Δ and/or Δ₁ and/or Δ₂ can be specified in the system specifications and/or configured or updated by SIB or RRC or MAC CE or L1 control (e.g., DCI Format) signaling. In one example, Δ and/or Δ₁ and/or Δ₂ is determined by a sub-carrier spacing (SCS) of the trigger/WUS or channel conveying configuration or the carrier(s) or BWP(s) to which the configuration applies. In one example, Δ and/or Δ₁ and/or Δ₂ is determined by the smallest sub-carrier spacing (SCS) of the trigger/WUS and/or channel conveying configuration and/or the carrier(s) and/or BWP(s) to which the configuration applies. In one example, Δ and/or Δ₁ and/or Δ₂ is determined by the largest sub-carrier spacing (SCS) of the trigger/WUS and/or channel conveying configuration and/or the carrier(s) and/or BWP(s) to which the configuration applies.

In one example, the configuration indicated by the channel and is applied after a gap G from the channel conveying the configuration information. In one example, G can be in time-units and/or symbols and/or slots and/or sub-frames and/or frames. In one example, G is from the end of the channel as illustrated in FIG. 15. In one example, G is from the start of the channel. In one example, the new configuration is applied at the start of the first time-unit or symbol or slot or sub-frame or frame that starts after a gap G from the end or start of the channel conveying the configuration information or from the end or start of the time-unit or slot or sub-frame that contains the channel conveying the configuration information. In one example, the time-unit or symbol or slot is determined by a sub-carrier spacing (SCS) of the trigger/WUS or channel conveying configuration or the carrier(s) or BWP(s) to which the configuration applies. In one example, the time-unit or symbol or slot is determined by the smallest sub-carrier spacing (SCS) of the trigger/WUS and/or channel conveying configuration and/or the carrier(s) and/or BWP(s) to which the configuration applies. In one example, the time-unit or symbol or slot is determined by the largest sub-carrier spacing (SCS) of the trigger/WUS and/or channel conveying configuration and/or the carrier(s) and/or BWP(s) to which the configuration applies.

In one example, in the aforementioned examples, G can be a single value. In one example, in the aforementioned examples, G can be within a range between G₁ and G₂.

In the aforementioned examples, G and/or G₁ and/or G₂ can be specified in the system specifications and/or configured or updated by SIB or RRC or MAC CE or L1 control (e.g., DCI Format) signaling. In one example, G and/or G₁ and/or G₂ is determined by the SCS of the trigger/WUS or channel conveying configuration information or the carrier(s) or BWP(s) to which the configuration applies. In one example, G and/or G₁ and/or G₂ is determined by the smallest SCS of the trigger/WUS and/or channel conveying configuration information and/or of the carrier(s) and/or BWP(s) to which the configuration applies. In one example, G and/or G₁ and/or G₂ is determined by the largest SCS of the trigger/WUS and/or channel conveying configuration information and/or of the carrier(s) and/or BWP(s) to which the configuration applies.

In one example, the channel with configuration information is a physical layer downlink control channel (e.g., PDCCH). In one example, the PDCCH is transmitted in a CORESET. In one example, the PDCCH is transmitted in a search space. In one example, the search space is a common search space.

In one example, the channel with configuration information is a physical layer downlink shared channel (e.g., PDSCH). In one example, the PDSCH is scheduled (e.g., scheduling determines resources and/or payload size and code rate) by a PDCCH. In one example, the PDCCH is transmitted in a CORESET. In one example, the PDCCH is transmitted in a search space. In one example, the search space is a common search space. In one example, the configuration information is included in downlink control information (DCI) in PDSCH. In one example, the configuration information is included in a MAC CE in PDSCH. In one example, the configuration information is included in a ASN.1 message or RRC message in PDSCH.

In one example, the time and frequency resources for the channel conveying the configuration information is configured or update SIB or RRC or MAC CE or L1 control signaling.

In one example, the resources and/or payload size and/or modulation scheme and/or code rate for the channel conveying the configuration information is configured or update SIB or RRC or MAC CE or L1 control signaling. In one example, the resources and/or payload size and/or modulation scheme and/or code rate for the channel conveying the configuration information is signaled by the WUS/trigger.

In one example, as described later in this disclosure:
multiple configurations and associated indices are configured by RRC and/or SIB signaling
Signaling in the channel with configuration information (e.g., L1 control signaling (e.g., DCI Format) or MAC CE/RRC/ASN.1 signaling) can be used to indicate one or more indices for configuration to apply after a gap G from the channel with configuration information.

FIG. 16 illustrates an example of UE triggering 1600 and application of configuration information according to embodiments of the present disclosure. For example, trigger 1600 can be transmitted by the UE 116 of FIG. 3. This example is for illustration only and other embodiments can be used without departing from the scope of the present disclosure.

In another example, the UE (e.g., the UE 116) can send a trigger or a wake-up-signal to the network to transmit a channel with configuration information, for example when the UE enters into a new cell. In response, the network transmits a channel conveying configuration information as illustrated in FIG. 16. In one example, the WUS is a signal received by a low-power receiver, after the gNB (e.g., the BS 102) receives the WUS by a low-power radio, the gNB transmits a channel conveying configuration information. In one example, the WUS is a sequence-based signal. In one example, the channel with configuration information is transmitted after a gap Δ from the trigger or wake-up signal from the UE. In one example, Δ can be in time-units and/or symbols and/or slots and/or sub-frames and/or frames. In one example, Δ is from the end of the trigger/WUS to the start of the channel conveying configuration information as illustrated in FIG. 16. In one example, Δ is from the start of the trigger/WUS to the start of the channel conveying configuration information. In one example, Δ is from the end of the trigger/WUS to the end of the channel conveying configuration information. In one example, Δ is from the start of the trigger/WUS to the end of the channel conveying configuration information. In one example, the channel conveying the configuration information is transmitted in a first time-unit or slot or sub-frame or frame that starts after a gap Δ from the end or start of the trigger/WUS or from the end or start of the time-unit or slot or sub-frame that contains the trigger/WUS.

In one example, the time-unit or slot is determined by a sub-carrier spacing (SCS) of the trigger/WUS or channel conveying configuration or the carrier(s) or BWP(s) to which the configuration applies. In one example, the time-unit or slot is determined by the smallest sub-carrier spacing (SCS) of the trigger/WUS and/or channel conveying configuration and/or the carrier(s) and/or BWP(s) to which the configuration applies. In one example, the time-unit or slot is determined by the largest sub-carrier spacing (SCS) of the trigger/WUS and/or channel conveying configuration and/or the carrier(s) and/or BWP(s) to which the configuration applies.

In one example, the trigger/WUS is in a first carrier or band or BWP, the channel with configuration information is in a second carrier or band or BWP, and the configuration information is applied to a third carrier or band or BWP. In one example, the first and the second carrier/band/BWP are the same carrier/band/BWP. In one example, the first and the third carrier/band/BWP are the same carrier/band/BWP. In one example, the second and the third carrier/band/BWP are the same carrier/band/BWP. In one example, the first and the second and the third carrier/band/BWP are the same carrier/band/BWP.

In one example, the channel with configuration information in response to trigger/WUS includes cell-common configuration information. In one example, the channel with configuration information in response to trigger/WUS is to UEs in a cell. In one example, the channel with configuration information in response to trigger/WUS includes UE-group-common configuration information. In one example, the channel with configuration information in response to trigger/WUS is to a UE group (group of UEs including UE sending the trigger/WUS). In one example, the channel with configuration information in response to trigger/WUS includes UE-specific configuration information for the UE sending the trigger/WUS. In one example, the channel with configuration information is to the UE sending the trigger/WUS.

In one example, in the aforementioned examples, Δ can be a single value. In one example, in the aforementioned examples, Δ can be within a range between Δ₁ and Δ₂.

In the aforementioned examples, Δ and/or Δ₁ and/or Δ₂ can be specified in the system specifications and/or configured or updated by SIB or RRC or MAC CE or L1 control (e.g., DCI Format) signaling. In one example, Δ and/or Dᵢ and/or Δ₂ is determined by a sub-carrier spacing (SCS) of the trigger/WUS or channel conveying configuration or the carrier(s) or BWP(s) to which the configuration applies. In one example, Δ and/or Δ₁ and/or Δ₂ is determined by the smallest sub-carrier spacing (SCS) of the trigger/WUS and/or channel conveying configuration and/or the carrier(s) and/or BWP(s) to which the configuration applies. In one example, Δ and/or Δ₁ and/or Δ₂ is determined by the largest sub-carrier spacing (SCS) of the trigger/WUS and/or channel conveying configuration and/or the carrier(s) and/or BWP(s) to which the configuration applies.

In one example, the configuration indicated by the channel and is applied after a gap G from the channel conveying the configuration information. In one example, G can be in time-units and/or symbols and/or slots and/or sub-frames and/or frames. In one example, G is from the end of the channel as illustrated in FIG. 16. In one example, G is from the start of the channel. In one example, the new configuration is applied at the start of the first time-unit or symbol or slot or sub-frame or frame that start after a gap G from the end or start of the channel conveying the configuration information or from the end or start of the time-unit or slot or sub-frame that contains the channel conveying the configuration information. In one example, the time-unit or symbol or slot is determined by a sub-carrier spacing (SCS) of the trigger/WUS or channel conveying configuration or the carrier(s) or BWP(s) to which the configuration applies. In one example, the time-unit or symbol or slot is determined by the smallest sub-carrier spacing (SCS) of the trigger/WUS and/or channel conveying configuration and/or the carrier(s) and/or BWP(s) to which the configuration applies. In one example, the time-unit or symbol or slot is determined by the largest sub-carrier spacing (SCS) of the trigger/WUS and/or channel conveying configuration and/or the carrier(s) and/or BWP(s) to which the configuration applies.

In one example, in the aforementioned examples, G can be a single value. In one example, in the aforementioned examples, G can be within a range between G₁ and G₂.

In the aforementioned examples, G and/or G₁ and/or G₂ can be specified in the system specifications and/or configured or updated by SIB or RRC or MAC CE or L1 control (e.g., DCI Format) signaling. In one example, G and/or G₁ and/or G₂ is determined by the SCS of the trigger/WUS or channel conveying configuration information or the carrier(s) or BWP(s) to which the configuration applies. In one example, G and/or G₁ and/or G₂ is determined by the smallest SCS of the trigger/WUS and/or channel conveying configuration information and/or of the carrier(s) and/or BWP(s) to which the configuration applies. In one example, G and/or G₁ and/or G₂ is determined by the largest SCS of the trigger/WUS and/or channel conveying configuration information and/or of the carrier(s) and/or BWP(s) to which the configuration applies.

In one example, the channel with configuration information is a physical layer downlink control channel (e.g., PDCCH). In one example, the PDCCH is transmitted in a CORESET. In one example, the PDCCH is transmitted in a search space. In one example, the search space is a common search space.

In one example, the channel with configuration information is a physical layer downlink shared channel (e.g., PDSCH). In one example, the PDSCH is scheduled (e.g., scheduling determines resources and/or payload size and code rate) by a PDCCH. In one example, the PDCCH is transmitted in a CORESET. In one example, the PDCCH is transmitted in a search space. In one example, the search space is a common search space. In one example, the configuration information is included in downlink control information (DCI) in PDSCH. In one example, the configuration information is included in a MAC CE in PDSCH. In one example, the configuration information is included in a ASN.1 message or RRC message in PDSCH.

In one example, the time and frequency resources for the channel conveying the configuration information is configured or update SIB or RRC or MAC CE or L1 control signaling.

In one example, the resources and/or payload size and/or modulation scheme and/or code rate for the channel conveying the configuration information is configured or update SIB or RRC or MAC CE or L1 control signaling. In one example, the resources and/or payload size and/or modulation scheme and/or code rate for the channel conveying the configuration information is signaled by the WUS/trigger.

In one example, as described later in this disclosure:
multiple configurations and associated indices are configured by RRC and/or SIB signaling
Signaling in the channel with configuration information (e.g., L1 control signaling (e.g., DCI Format) or MAC CE/RRC/ASN.1 signaling) can be used to indicate one or more indices for configuration to apply after a gap G from the channel with configuration information.

The configuration information provided to the UE (e.g., the UE 116) applies to a time interval associated with the configuration information as aforementioned. In one example, the configuration information applies until new configuration information is provided taking into account the processing latency to receive, process and apply the configuration information. As aforementioned, the configuration information can apply to UEs in a cell, or a group of UEs or to a specific UE. In one example, the scope of the configuration information can be determined by configuration. In one example the scope of the configuration information can be determined by an RNTI used to scramble the CRC of the configuration information (e.g., common RNTI, or UE-group RNTI or UE-specific RNTI).

In one example, configuration information provides information about downlink (DL) resources in the time interval corresponding to the channel (instance of the channel) conveying the configuration information. In one example, the configuration information provides information about location of DL time-units (e.g., symbols, slots, sub-frames, frames, etc.) used for DL in the corresponding interval. In one example, the configuration information provides a bitmap or field-map of the DL time-units and/or symbols and/or slots and/or sub-frames, etc. In one example, the field-map can be a field-map of time-units or slots or sub-frames within an interval (e.g., a time-unit or a slot or sub-frame in the interval corresponds to a field in the field-map), a field in the field-map can indicate that corresponding time-unit or slot or sub-frame is DL, or has no DL symbols, or has some DL symbols. In one example, if a time-unit or slot or sub-frame has some DL symbols, a second parameter can indicate the number of DL symbols, or the second parameter can be a bitmap or a field-map with each symbol in the time-unit or slot or sub-frame corresponding to a bit in the bitmap or a field in the field-map that can indicate whether or not the corresponding symbol is a DL symbol. In one example, the configuration information provides a length of DL interval within a pattern, e.g., the length of the DL interval can be in units of time-units and/or symbols and/or slots and/or sub-frames, etc. In one example, the configuration information provides a starting or an ending location of a DL interval within a pattern, e.g., the starting or the ending location of the DL interval can be in units of time-units and/or symbols and/or slots and/or sub-frames and/or frames. In one example, the configuration information provides a length of the pattern, wherein the length of the pattern can be in units of time-units and/or symbols and/or slots and/or sub-frames and/or frames. In one example, there is one pattern that repeats cyclically within the interval. In one example, the configuration information provides multiple (e.g., 2) patterns that can repeat cyclically (e.g., pattern1, pattern2, pattern1, pattern2, . . . ) within the interval.

In one example, configuration information provides information about uplink (UL) resources in the time interval corresponding to the channel (instance of the channel) conveying the configuration information. In one example, the configuration information provides information about location of UL time-units (e.g., symbols, slots, sub-frames, frames, etc.) used for UL in the corresponding interval. In one example, the configuration information provides a bitmap or field-map of the UL time-units and/or symbols and/or slots and/or sub-frames, etc. In one example, the field-map can be a field-map of time-units or slots or sub-frames within an interval (e.g., a time-unit or a slot or sub-frame in the interval corresponds a field in the field-map), a field in the field-map can indicate that corresponding time-unit or slot or sub-frame is UL, or has no UL symbols, or has some UL symbols. In one example, if a time-unit or a slot or sub-frame has some UL symbols, a second parameter can indicate the number of UL symbols, or the second parameter can be a bitmap or a field-map with each symbol in the time-unit or slot or sub-frame corresponding to a bit in the bitmap or a field in the field-map that can indicate whether or not the corresponding symbol is a UL symbol. In one example, the configuration information provides a length of UL interval within a pattern, e.g., the length of the UL interval can be in units of time-units and/or symbols and/or slots and/or sub-frames, etc. In one example, the configuration information provides a starting or an ending location of a UL interval within a pattern, e.g., the starting or the ending location of the UL interval can be in units of time-units and/or symbols and/or slots and/or sub-frames and/or frames. In one example, the configuration information provides a length of the pattern, wherein the length of the pattern can be in units of time-units and/or symbols and/or slots and/or sub-frames and/or frames. In one example, there is one pattern that repeats cyclically within the interval. In one example, the configuration information provides multiple (e.g., 2) patterns that can repeat cyclically (e.g., pattern1, pattern2, pattern1, pattern2, . . . ) within the interval.

In one example, configuration information provides information about flexible resources in the time interval corresponding to the channel (instance of the channel) conveying the configuration information, wherein flexible resources can be used for DL or UL (or SL). In one example, the configuration information provides information about location of flexible time-units (e.g., symbols, slots, sub-frames, frames, etc.) used for flexible resources in the corresponding interval. In one example, the configuration information provides a bitmap or field-map of the flexible time-units and/or symbols and/or slots and/or sub-frames, etc. In one example, the field-map can be a field-map of time-units or slots or sub-frames within an interval (e.g., a time-unit or a slot or sub-frame in the interval corresponds a field in the field-map), a field in the field-map can indicate that corresponding time-unit or slot or sub-frame is flexible, or has no flexible symbols, or has some flexible symbols. In one example, if a time-unit or a slot or sub-frame has some flexible symbols, a second parameter can indicate the number of flexible symbols, or the second parameter can be a bitmap or a field-map with each symbol in the time-unit or slot or sub-frame corresponding to a bit in the bitmap or a field in the field-map that can indicate whether or not the corresponding symbol is a flexible symbol. In one example, the configuration information provides a length of flexible interval within a pattern, e.g., the length of the flexible interval can be in units of time-units and/or symbols and/or slots and/or sub-frames, etc. In one example, the configuration information provides a starting or an ending location of a flexible interval within a pattern, e.g., the starting or the ending location of the flexible interval can be in units of time-units and/or symbols and/or slots and/or sub-frames and/or frames. In one example, the configuration information provides a length of the pattern, wherein the length of the pattern can be in units of time-units and/or symbols and/or slots and/or sub-frames and/or frames. In one example, there is one pattern that repeats cyclically within the interval. In one example, the configuration information provides multiple (e.g., 2) patterns that can repeat cyclically (e.g., pattern1, pattern2, pattern1, pattern2, . . . ) within the interval. In one example, flexible resources can be used for DL or UL transmissions. In one example, flexible resources can be used for DL or UL or SL transmissions. In one example, flexible resources can be used for communications (e.g., DL or UL or SL) or for sensing. In one example, flexible resources are implicitly signaled, e.g., remaining resources not signaled to be used for DL or UL (or other purposes) are flexible resources.

In one example, configuration information provides information about SL resources in the time interval corresponding to the channel (instance of the channel) conveying the configuration information. In one example, the configuration information provides information about location of SL time-units (e.g., symbols, slots, sub-frames, frames, etc.) used for SL in the corresponding interval. In one example, the configuration information provides a bitmap or field-map of the SL time-units and/or symbols and/or slots and/or sub-frames, etc. In one example, the field-map can be a field-map of time-units or slots or sub-frames within an interval (e.g., a time-unit or slot or sub-frame in the interval correspond to a field in the field-map), a field in the field-map can indicate that corresponding time-unit or slot or sub-frame is SL, or has no SL symbols, or has some SL symbols. In one example, if a time-unit or slot or sub-frame has some SL symbols, a second parameter can indicate the number of SL symbols, or the second parameter can be a bitmap or a field-map with each symbol in the time-unit or slot or sub-frame corresponding to a bit in the bitmap or a field in the field-map that can indicate whether or not the corresponding symbol is a SL symbol. In one example, for a bitmap, “1” can indicate that the corresponding time-unit or symbol or slot or sub-frame or frame is used for SL, and “0” can indicate that the corresponding time-unit or symbol or slot or sub-frame or frame is not used for SL or vice versa. In one example, the configuration information provides a length of SL interval within a pattern, e.g., the length of the SL interval can be in units of time-units and/or symbols and/or slots and/or sub-frames, etc. In one example, the configuration information provides a starting or an ending location of a SL interval within a pattern, e.g., the starting or the ending location of the SL interval can be in units of time-units and/or symbols and/or slots and/or sub-frames and/or frames. In one example, the configuration information provides a length of the pattern, wherein the length of the pattern can be in units of time-units and/or symbols and/or slots and/or sub-frames and/or frames. In one example, there is one pattern that repeats cyclically within the interval. In one example, the configuration information provides multiple (e.g., 2) patterns that can repeat cyclically (e.g., pattern1, pattern2, pattern1, pattern2, . . . ) within the interval.

In a variant of the example herein, UL+SL time-units and/or symbols and/or slots and/or sub-frames and/or frames are jointly configured, wherein the configured time-unit and/or symbols and/or slot and/or sub-frame and/or frame can be used for UL or for SL, or for UL on some frequency resources and for SL on other frequency resources. In one example, a further configuration information can indicate which resources are used for UL and which resources are used for SL.

In one example, configuration information provides information about sensing resources in the time interval corresponding to the channel (instance of the channel) conveying the configuration information. In one example, the configuration information provides information about location of sensing time-units (e.g., symbols, slots, sub-frames, frames, etc.) used for sensing in the corresponding interval. In one example, the configuration information provides a bitmap or field-map of the sensing time-units and/or symbols and/or slots and/or sub-frames, etc. In one example, the field-map can be a field-map of time-units or slots or sub-frames within an interval (e.g., a time-unit or slot or sub-frame in the interval corresponds to a field in the field-map), a field in the field-map can indicate that corresponding time-unit or slot or sub-frame is used for sensing, or has no sensing symbols, or has some sensing symbols. In one example, if a time-unit or slot or sub-frame has some sensing symbols, a second parameter can indicate the number of sensing symbols, or the second parameter can be a bitmap or a field-map with each symbol in the time-unit or slot or sub-frame corresponding to a bit in the bitmap or a field in the field-map that can indicate whether or not the corresponding symbol is a sensing symbol. In one example, for a bitmap, “1” can indicate that the corresponding time-unit or symbol or slot or sub-frame or frame is used for sensing, and “0” can indicate that the corresponding time-unit or symbol or slot or sub-frame or frame is not used for sensing or vice versa. In one example, the configuration information provides a length of sensing interval within a pattern, e.g., the length of the sensing interval can be in units of time-units and/or symbols and/or slots and/or sub-frames, etc. In one example, the configuration information provides a starting or an ending location of a sensing interval within a pattern, e.g., the starting or the ending location of the sensing interval can be in units of time-units and/or symbols and/or slots and/or sub-frames and/or frames. In one example, the configuration information provides a length of the pattern, wherein the length of the pattern can be in units of time-units and/or symbols and/or slots and/or sub-frames and/or frames. In one example, there is one pattern that repeats cyclically within the interval. In one example, the configuration information provides multiple (e.g., 2) patterns that can repeat cyclically (e.g., pattern1, pattern2, pattern1, pattern2, . . . ) within the interval.

In one example, configuration information provides information about idle time in the time interval corresponding to the channel (instance of the channel) conveying the configuration information, wherein idle time is time where there is no transmission or reception and the transceiver (e.g., in gNB and/or UE) can sleep or be turned off or operate in low power mode. In one example, the configuration information provides information about location of idle time-units (e.g., symbols, slots, sub-frames, frames, etc.) used for idle durations in the corresponding interval. In one example, the configuration information provides a bitmap or field-map of the idle time-units and/or symbols and/or slots and/or sub-frames, etc. In one example, the field-map can be a field-map of time-units or slots or sub-frames within an interval (e.g., a time-unit or slot or sub-frame in the interval corresponds to a field in the field-map), a field in the field-map can indicate that corresponding time-unit or slot or sub-frame is idle, or has no idle symbols, or has some idle symbols. In one example, if a slot or sub-frame has some idle symbols, a second parameter can indicate the number of idle symbols, or the second parameter can be a bitmap or a field-map with each symbol in the time-unit or slot or sub-frame corresponding to a bit in the bitmap or a field in the field-map that can indicate whether or not the corresponding symbol is an idle symbol. In one example, for a bitmap, “1” can indicate that the corresponding time-unit or symbol or slot or sub-frame or frame is idle, and “0” can indicate that the corresponding time-unit or symbol or slot or sub-frame or frame is not idle or vice versa. In one example, the configuration information provides a length of idle interval within a pattern, e.g., the length of the idle interval can be in units of time-units and/or symbols and/or slots and/or sub-frames, etc. In one example, the configuration information provides a starting or an ending location of an idle interval within a pattern, e.g., the starting or the ending location of the idle interval can be in units of time-units and/or symbols and/or slots and/or sub-frames and/or frames. In one example, the configuration information provides a length of the pattern, wherein the length of the pattern can be in units of time-units and/or symbols and/or slots and/or sub-frames and/or frames. In one example, there is one pattern that repeats cyclically within the interval. In one example, the configuration information provides multiple (e.g., 2) patterns that can repeat cyclically (e.g., pattern1, pattern2, pattern1, pattern2, . . . ) within the interval.

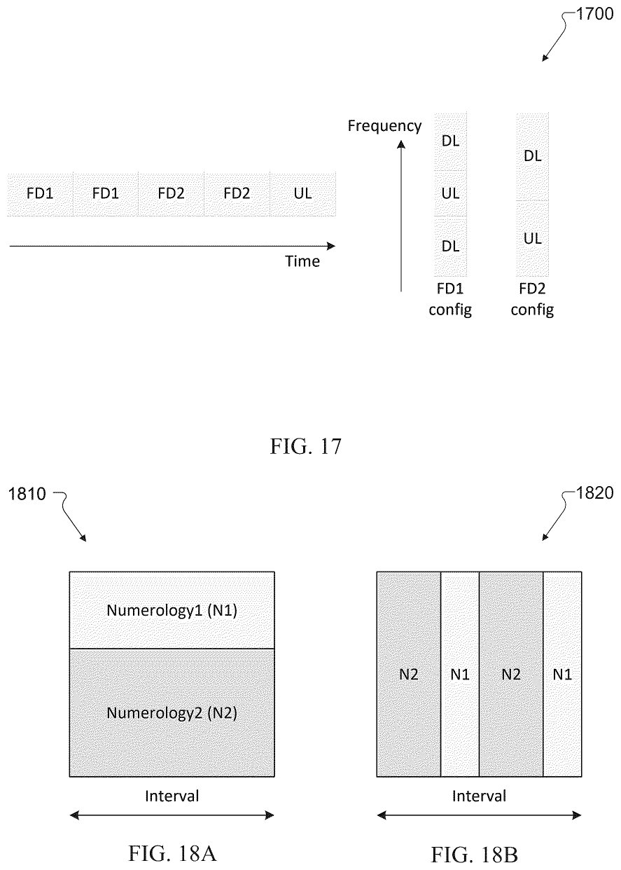

FIG. 17 illustrates a timeline 1700 of example full duplex configurations according to embodiments of the present disclosure. For example, timeline 1700 can be followed by the UE 116 and the BS 102 of FIG. 1. This example is for illustration only and other embodiments can be used without departing from the scope of the present disclosure.

In one example, configuration information provides information about full-duplex (FD) resources in the time interval corresponding to the channel (instance of the channel) conveying the configuration information, wherein FD resources are time durations during which there is DL and UL (and SL) transmissions, the transmissions can be in different sub-bands or can overlap in frequency. In one example, there are multiple FD configurations, for example FD1 can be a first FD configuration, FD2 can be a second FD configurations, . . . . Wherein each FD configuration for a time-duration, defines the frequency resources (of the time duration) used for DL and the frequency resources (of the time duration) used for UL and the frequency resources (of the time duration) used for DL and UL (e.g., flexible resources). In one example, there are frequency resources for SL and/or for SL+UL and/or for SL+DL and/or for SL+DL+UL. In one example, there are frequency resources for sensing. In one example, there are frequency resources that can be left idle. In one example, these are flexible frequency resources. In one example, the FD configuration information provides a bitmap or field-map of the frequency-units and/or sub-carriers and/or PRBs and/or sub-channels used for DL and/or UL and/or SL or used for sensing or are left idle or flexible resources. In one example, for a bitmap, “1” can indicate that the corresponding frequency-unit and/or time-unit is used for DL or UL or SL or sensing or left idle, and “0” can indicate that the corresponding frequency-unit and/or time-unit is not used for DL or UL or SL or sensing or left idle or vice versa. In one example, the FD configuration information provides a region determined by a length and/or a start frequency and/or an end frequency for DL and/or UL and/or SL or used for sensing or are left idle or flexible resources, wherein, the length and/or start frequency and/or end frequency can be in frequency-units and/or sub-carriers and/or RBs and/or sub-channels. In one example, there can be one or more regions for DL and/or UL and/or SL or used for sensing or are left idle or flexible resources. In one example, flexible resources can be used for DL or UL transmissions. In one example, flexible resources can be used for DL or UL or SL transmissions. In one example, flexible resources can be used for communications (e.g., DL or UL or SL) or for sensing. In one example, flexible resources are resources that are not configured for anything else.

In one example, the configuration information provides information about location of time-units (e.g., symbols, slots, sub-frames, frames, etc.) used for each FD configuration in the corresponding interval. In one example, the configuration information provides a bitmap or field-map of time-units and/or symbols and/or slots and/or sub-frames, etc., for each FD configuration. In one example, the field-map can be a field-map of time-units or slots or sub-frames within an interval (e.g., a time-unit or slot or sub-frame in the interval corresponds a field in the field-map), a field in the field-map can indicate that corresponding time-unit or slot or sub-frame is for an FD configuration, or has no symbols for an FD configuration, or has some symbols for an FD configuration. In one example, if a time-unit or slot or sub-frame has some symbols for an FD configuration, a second parameter can indicate the number of symbols for the FD configuration, or the second parameter can be a bitmap or a field-map with each symbol in the time-unit or slot or sub-frame corresponding to a bit in the bitmap or a field in the field-map that can indicate whether or not the corresponding symbol is a symbol for the FD configuration. In one example, for a bitmap, “1” can indicate that the corresponding time-unit or symbol or slot or sub-frame or frame is used for FD, and “0” can indicate that the corresponding time-unit or symbol or slot or sub-frame or frame is not used for FD or vice versa. In one example, the configuration information provides a length of a FD configuration interval within a pattern, e.g., the length of the FD configuration interval can be in units of time-units and/or symbols and/or slots and/or sub-frames, etc. In one example, the configuration information provides a starting or an ending location of an FD configuration interval within a pattern, e.g., the starting or the ending location of the FD configuration interval can be in units of time-units and/or symbols and/or slots and/or sub-frames and/or frames. In one example, the configuration information provides a length of the pattern, wherein the length of the pattern can be in units of time-units and/or symbols and/or slots and/or sub-frames and/or frames. In one example, there is one pattern that repeats cyclically within the interval. In one example, the configuration information provides multiple (e.g., 2) patterns that can repeat cyclically (e.g., pattern1, pattern2, pattern1, pattern2, . . . ) within the interval.

FIG. 17 illustrates an example, of a configuration with FD time durations. In the example of FIG. 17, there are two FD configurations, FD1 has two DL sub-bands and one UL sub-band as shown, while FD2 has one DL sub-band and one UL-subband. In the example of FIG. 17, a pattern is defined with 5 time-units. The first two time-units in the pattern use FD1 configuration. The next two time units in the pattern use FD2 configuration. The last time-unit is an UL time unit. In one example, the configuration of the pattern can be by a field-map that indicates FD1, FD1, FD2, FD2, UL. In another example, the configuration of the pattern can indicate that FD1 has a start position of 0 and a duration of 2 time-units, FD2 has a start position of 2 and duration of 2 time-units, and UL has a start position of 4 and duration of 1 time-unit. In a variant example, the start position or the end position is not provided, but is derived from the previous durations of fields in the pattern. In one example, for a bitmap, “1” can indicate that the corresponding time-unit or symbol or slot or sub-frame or frame is used for FD1, and “0” can indicate that the corresponding time-unit or symbol or slot or sub-frame or frame is used for FD2 or vice versa.

In one example, configuration information provides information about UE initiated (UI) resources in the time interval corresponding to the channel (instance of the channel) conveying the configuration information. In one example, the configuration information provides information about location of UI time-units (e.g., symbols, slots, sub-frames, frames, etc.) used for UI in the corresponding interval. In one example, the configuration information provides a bitmap or field-map of the UI time-units and/or symbols and/or slots and/or sub-frames, etc. In one example, the field-map can be a field-map of time-units or slots or sub-frames within an interval (e.g., a time-unit or slot or sub-frame in the interval corresponds a field in the field-map), a field in the field-map can indicate that corresponding time-unit or slot or sub-frame is UI, or has no UI symbols, or has some UI symbols. In one example, if a time-unit or slot or sub-frame has some UI symbols, a second parameter can indicate the number of UI symbols, or the second parameter can be a bitmap or a field-map with each symbol in the time-unit or slot or sub-frame corresponding to a bit in the bitmap or a field in the field-map that can indicate whether or not the corresponding symbol is a UI symbol. In one example, for a bitmap, “1” can indicate that the corresponding time-unit or symbol or slot or sub-frame or frame is used for UI, and “0” can indicate that the corresponding time-unit or symbol or slot or sub-frame or frame is not used for UI or vice versa. In one example, the configuration information provides a length of UI interval within a pattern, e.g., the length of the UI interval can be in units of time-units and/or symbols and/or slots and/or sub-frames, etc. In one example, the configuration information provides a starting or an ending location of a UI interval within a pattern, e.g., the starting or the ending location of the UI interval can be in units of time-units and/or symbols and/or slots and/or sub-frames and/or frames. In one example, the configuration information provides a length of the pattern, wherein the length of the pattern can be in units of time-units and/or symbols and/or slots and/or sub-frames and/or frames. In one example, there is one pattern that repeats cyclically within the interval. In one example, the configuration information provides multiple (e.g., 2) patterns that can repeat cyclically (e.g., pattern1, pattern2, pattern1, pattern2, . . . ) within the interval. In a variant example, UI can be replaced by network controlled (NC) (or allocated) resources and the example herein apply by replacing UI with NC. In one example, NC resources are UL and/or SL resources that are not configured as UI resources (or not configured for other UL transmissions).

In one example, UI resources can be used for UL transmissions. In one example, UI can be resources can be used for SL. In one example, UI resources can be used for UL transmissions or SL transmissions. In one example, a first UI is configured for UL and a second UI is configured for SL. In one example, a first UI is configured for UL and/or SL, a second UI is configured for UL and/or SL, a third UI is configured for UL and/or SL, and so on, the different configurations can be used for traffic with different characteristics (e.g., priority, QoS, etc.).

In one example, the UI resources are configured as a subset of the UL and/or SL resources. In the example, the UI resources are configured using a bitmap or a field-map of the UL and/or SL resources (in time and/or frequency domains). In the example, the UI resources are configured using a starting position and/or ending position and/or length within the UL and/or SL resources (in time and/or frequency domains).

In one example, for UI resources the access mechanism can be sensing-based, e.g., similar to SL sensing where a user indicates future resource reservations and other users receive this information and avoid reserved resources based on reference signal received power (RSRP) and priority. In one example, for UI resources the access mechanism is based on listen-before-talk (LBT), where the user checks that no other user is using the channel before transmitting. In one example, for UI resources the access mechanism can be based on non-orthogonal multiple access (NOMA).

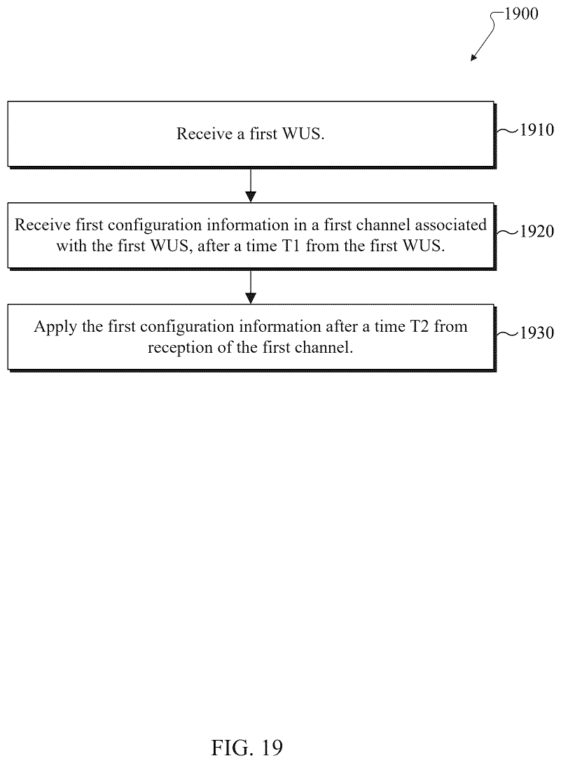

FIGS. 18A and 18B illustrate an example numerology configuration 1810 and 1820 according to embodiments of the present disclosure. For example, numerology configuration 1810 and 1820 can be received by any of the UEs 111-116 of FIG. 1, such as the UE 116. This example is for illustration only and other embodiments can be used without departing from the scope of the present disclosure.

In one example, configuration information provides information about numerology (or numerologies) in the time interval corresponding to the channel (instance of the channel) conveying the configuration information. Wherein, numerology can include: (1) sub-carrier spacing configuration, and/or (2) length of slot (e.g. in symbols or units of time), and/or (3) length of cyclic prefix. In one example, there is one numerology used within the interval. In one example, there can be more than one numerology used within the interval. In one example, a first numerology is used in a first set of frequency resources (e.g., defined by bitmap of frequency-units or start/end/length of frequency units), a second set of numerology is used for a second set of frequency resources, etc., as illustrated in FIG. 18(A). In one example, a first numerology is used in a first set of time resources (e.g., defined by bitmap of time-units or start/end/length/period/offset of time units), a second set of numerology is used for a second set of time resources, etc., as illustrated in FIG. 18(B). In one example, if a first set of frequencies uses a first SCS, and a second set of frequencies uses a second SCS, a frequency gap f_{gap} can be configured between the first set of frequencies and the second set of frequencies, wherein f_{gap} can be specified in the system specifications and/or configured or updated by SIB or RRC or MAC CE or L1 control (e.g., DCI Format) signaling. In one example, f_{gap} can be in frequency-units and/or sub-carriers and/or RBs and/or sub-channels. In one example, f_{gap} can depend on the first SCS and the second SCS. In one example, f_{gap} can depend on the difference or ratio of the first SCS and the second SCS. In one example, if a first set of time resources uses a first SCS, and a second set of time resources uses a second SCS, a time gap t_{gap} can be configured between the first set of time resources and the second set of time resources, wherein t_{gap} can be specified in the system specifications and/or configured or updated by SIB or RRC or MAC CE or L1 control (e.g., DCI Format) signaling. In one example, t_{gap} can be in time-units and/or symbols and/or slots and/or sub-frames and/or frames. In one example, t_{gap} can depend on the first SCS and the second SCS. In one example, t_{gap} can depend on the difference or ratio of the first SCS and the second SCS.

In one example, configuration information provides information about carrier(s) configuration in the time interval corresponding to the channel (instance of the channel) conveying the configuration information. In one example, the carrier(s) configuration includes the carrier(s) that are active or dormant or non-dormant in the time-interval. In one example, the carrier(s) configuration includes the BW of the carrier(s) (e.g., in RBs or sub-carriers or sub-channels or frequency-units). In one example, the carrier(s) configuration includes information about the carrier(s) in a same carrier group for scheduling (e.g., cross carrier scheduling within the carrier group or scheduling across multiple carriers within the carrier group).

In one example, configuration information provides information about BWP(s) configuration in the time interval corresponding to the channel (instance of the channel) conveying the configuration information. In one example, the BWP(s) configuration information includes the bandwidth of the BWP(s) (e.g., in RBs or sub-carriers or sub-channels or frequency-units). In one example, the BWP(s) configuration information includes the location of the BWP(s). In one example, the BWP(s) configuration information includes the sub-carrier spacing of the BWP(s). In one example, the BWP(s) configuration information includes the cyclic prefix (CP) of the BWP(s). In one example, BWP configuration includes multiple downlink common configurations (e.g., multiple configurations for PDCCH config common or multiple configurations for PDSCH config common), the BWP(s) configuration information includes index of one of the multiple configurations to apply for a BWP. In one example, BWP configuration includes multiple downlink dedicated configurations (e.g., multiple configurations for PDCCH config or multiple configurations for PDSCH config or multiple configurations for semi-persistent scheduling (SPS) config or multiple configurations for radio link monitor config), the BWP(s) configuration information includes index of one of the multiple configurations to apply for a BWP—this for example, can be incase the channel conveying the configuration information is to a specific UE or UEs using a same BWP. In one example, BWP configuration includes multiple uplink common configurations (e.g., multiple configurations for RACH config common or multiple configurations for PUSCH config common or multiple configurations for PUCCH config common), the BWP(s) configuration information includes index of one of the multiple configurations to apply for a BWP. In one example, BWP configuration includes multiple uplink dedicated configurations (e.g., multiple configurations for PUCCH config or multiple configurations for PUSCH config or multiple configurations for SRS config or multiple configurations for configured grant config or multiple configurations for beam failure recovery config), the BWP(s) configuration information includes index of one of the multiple configurations to apply for a BWP—this for example, can be incase the channel conveying the configuration information is to a specific UE or UEs using a same BWP.

In one example, configuration information provides information about SS/PBCH Block (SSB) configuration in the time interval corresponding to the channel (instance of the channel) conveying the configuration information. In one example, SSB configuration information includes the period of the SSB. In one example, SSB configuration information includes the offset of the SSB, e.g., relative to SFN #0. In one example, SSB configuration information includes SSB positions in burst (e.g., as bitmap), e.g., time domain positions of the transmitted SS-blocks in a half frame with SS/PBCH blocks as defined in [REF 3], for example, a value of 1 in bit of the bitmap can indicate the SSB index corresponding to the bit is transmitted by gNB (e.g., the BS 102) or expected to be received by UE.

In one example, configuration information provides information about RACH configuration in the time interval corresponding to the channel (instance of the channel) conveying the configuration information. In one example, RACH configuration information includes frequency domain resources (e.g., start frequency or number of FDMed PRACH occasions). In one example, RACH configuration information includes time domain information of PRACH occasions (ROs), e.g., provided by prach-ConfigurationIndex.

In one example, configuration information provides information about SIB (e.g., SIB1) configuration in the time interval corresponding to the channel (instance of the channel) conveying the configuration information. In one example, SIB (e.g., SIB1) configuration information includes the period of a SIB (e.g., SIB1).

In one example, configuration information provides information about CORESET(s) in the time interval corresponding to the channel (instance of the channel) conveying the configuration information. In one example, CORESET(s) configuration information includes frequency domain resources of CORESET(s). In one example, CORESET(s) configuration information includes duration of CORESET(s). In one example, CORESET(s) configuration information includes control channel element (CCE) resource element group (REG) mapping type of CORESET(s). In one example, CORESET(s) configuration information includes precoder granularity of CORESET(s). In one example, CORESET(s) configuration information includes whether or not CORESET(s) follow the unified (or indicated) TCI state. In one example, CORESET(s) configuration information includes indication of which TCI state (incase multiple TCI states are indicated) the CORESET(s) follow.

In one example, configuration information provides information about search space set(s) configuration in the time interval corresponding to the channel (instance of the channel) conveying the configuration information. In one example, search space set(s) configuration information includes monitoring slot periodicity and/or offset (e.g., relative to SFN #0) of the search space set(s). In one example, search space set(s) configuration information includes duration (e.g., number of consecutive slots a search space occasion lasts for) of the search space set(s). In one example, search space set(s) configuration information includes monitoring symbols within a slot of the search space set(s). In one example, search space set(s) configuration information includes number of candidates for each aggregation level of the search space set(s).

In one example, configuration information provides information about CSI-RS configuration in the time interval corresponding to the channel (instance of the channel) conveying the configuration information. In one example, CSI-RS configuration information includes periodicity and/or offset (e.g., relative to SFN #0) for CSI-RS. In one example, CSI-RS configuration information includes number of ports and/or CDM Type and/or density and/or time domain allocation and/or frequency domain allocation for CSI-RS.

In one example, configuration information provides information about CSI report configuration in the time interval corresponding to the channel (instance of the channel) conveying the configuration information. In one example, CSI report configuration information includes periodicity and/or offset (e.g., relative to SFN #0) for CSI report. In one example, CSI report configuration information includes report content and/or report size for CSI report. In one example, CSI report configuration information includes UL transmission resources for CSI report. In one example, CSI report configuration information includes report quantity for CSI report.

In one example, configuration information provides information about SRS configuration in the time interval corresponding to the channel (instance of the channel) conveying the configuration information. In one example, SRS configuration information includes periodicity and/or offset (e.g., relative to SFN #0) for SRS. In one example, SRS configuration information includes number of SRS per slot and/or transmission comb for SRS. In one example, SRS configuration information includes number of ports and/or comb size and/or comb offset.

In one example, configuration information provides information about DMRS configuration in the time interval corresponding to the channel (instance of the channel) conveying the configuration information. In one example, DMRS configuration information includes DMRS length (e.g., of a DMRS bundle of symbols). In one example, DMRS configuration information includes DMRS position(s) within a time-unit (e.g., slot). In one example, DMRS configuration information includes DMRS type and/or [maximum] number of DMRS ports.

In one example, multiple configurations are configured by higher layer signaling, each configuration is associated with an index. In one example, the higher layer signaling is SIB signaling. In one example, the higher layer signaling is RRC signaling. In one example, the multiple configurations are configured for downlink (DL) resources, e.g., D₀, D₁, . . . . In one example, the multiple configurations are configured for uplink (UL) resources, e.g., U₀, U₁, . . . . In one example, the multiple configurations are configured for flexible resources, e.g., F₀, F₁, . . . . In one example, the multiple configurations are configured for SL resources, e.g., S₀, S₁, . . . . In one example, the multiple configurations are configured for sensing resources, e.g., Sn₀, Sn₁, . . . . In one example, the multiple configurations are configured for full-duplex resources, e.g., FD₀, FD₁, . . . . In one example, the multiple configurations are configured for UE initiated uplink (UL) resources, e.g., UI₀, UI₁, . . . . In one example, the multiple configurations are configured for numerology (SCS and/or CP), e.g., N₀, N₁, . . . . In one example, the multiple configurations are configured for BW, e.g., BW₀, BW₁, . . . . In one example, the multiple configurations are configured for active carriers, e.g., including corresponding bandwidth for each carrier, e.g., AC₀, AC₁, . . . . In one example, the multiple configurations are configured for RACH, e.g., R₀, R₁, . . . . In one example, the multiple configurations are configured for SSBs, e.g., SSB₀, SSB₁, . . . . In one example, the multiple configurations are configured for SIBs, e.g., SIB₀, SIB₁, . . . . In one example, the multiple configurations are configured for CORESETs, e.g., C₀, C₁, . . . . In one example, the multiple configurations are configured for search space set, e.g., SS₀, SS₁, . . . . In one example, the multiple configurations are configured for CSI-RS, e.g., CR₀, CR₁, . . . . In one example, the multiple configurations are configured for CSI, e.g., CSI₀, CSI₁, . . . . In one example, the multiple configurations are configured for SRS, e.g., SRS₀, SRS₁, . . . . In one example, the multiple configurations are configured for DMRS, e.g., DR₀, DR₁, . . . .

In one example, an index i can be associated with one or more of the aforementioned configurations, for example, index i can be associated with one or more of the following configurations Dᵢ₁ Uᵢ₂ Sᵢ₃ Snᵢ₄ FDᵢ₅ UIᵢ₆ Nᵢ₇ BWᵢ₈ ACᵢ₉ Rᵢ₁₀ SSBᵢ₁₁ SIBᵢ₁₂ Cᵢ₁₃ SSᵢ₁₄ CRᵢ₁₅ CSI₁₆ SRSᵢ₁₇ DRᵢ₁₈. In one example, i=i1=i2= . . . =i18.

In one example, one or more indices for corresponding configurations can be signaled e.g., through L1 control or DCI Format signaling, or through MAC CE/RRC/ANS.1 signaling, for example signaling in region 1 or signaling by a channel conveying configuration information as aforementioned. In one example,
a first index i corresponding a first subset of Dᵢ₁ Uᵢ₂ Sᵢ₃ Snᵢ₄ FDᵢ₅ UIᵢ₆ Nᵢ₇ BWᵢ₈ ACᵢ₉ Rᵢ₁₀ SSBᵢ₁₁ SIBᵢ₁₂ Cᵢ₁₃ SSᵢ₁₄ CRᵢ₁₅ CSIᵢ₁₆ SRSᵢ₁₇ DRᵢ₁₈, and/or
a second index j corresponding a second subset of Dⱼ₁ Uⱼ₂ Sⱼ₃ Snⱼ₄ FDⱼ₅ UIⱼ₆ Nⱼ₇ BWⱼ₈ ACⱼ₉ Rⱼ₁₀ SSBⱼ₁₁ SIBⱼ₁₂ Cⱼ₁₃ SSⱼ₁₄ CRⱼ₁₅ CSIⱼ₁₆ SRSⱼ₁₇ DRⱼ₁₈, (in one example, the first subset and the second subset are non-overlapping),
. . .
   can be signaled e.g., through L1 control or DCI Format signaling, or through MAC CE/RRC/ANS.1 signaling.

In one example, a default configuration corresponding to one or more of the examples herein is provided to the UE, if the UE doesn't receive a configuration of a time interval (e.g., based on expiration of a timer), the UE applies the default configuration. In one example, a UE is provided with multiple configurations and the UE can be indicated by RRC or MAC CE or L1 control (e.g., DCI Format) which of the multiple configurations to apply as a default configuration, when a UE doesn't receive a configuration of a time interval (e.g., after timer expires).

FIG. 19 illustrates an example method 1900 performed by a UE in a wireless communication system according to embodiments of the present disclosure. The method 1900 of FIG. 19 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1900 is for illustration only and other embodiments can be used without departing from the scope of the present disclosure.

The method begins with the UE receiving a first WUS (1910). The UE then receives first configuration information in a first channel associated with the first WUS, after a time T1 from the first WUS (1920). In various embodiments, the UE receives multiple configurations. Each configuration from the multiple configurations is associated with an index. The first configuration information is an index identifying one of the multiple configurations. For example, the first configuration information provides a type of a time-unit or a frequency-unit. The type is one of downlink, uplink, idle, or sensing. The UE then applies the first configuration information after a time T2 from reception of the first channel (1930).

In various embodiments, the UE transmit a second WUS, receives second configuration information in a second channel associated with the second WUS, after a time T3 from the second WUS, and applies the second configuration information after a time T4 from reception of the second channel.

In various embodiments, the UE receives third configuration information for code-block group (CBG) code-points. The third configuration information associates a CBG code-point with one or more CBGs. The UE receives a first transport block including a number of CBGs, identifies a CBG, from the number of CBGs, that is received in error, and when there is no CBG code-point corresponding to the CBG received in error, transmits a code-point X from the CBG code-points. The code-point X corresponds to all of the number of CBGs.

In various embodiments, the UE receives third configuration information for CBG code-points. The third configuration information associates a CBG code-point with one or more CBGs. The UE receives a first transport block including a number of CBGs, identifies a CBG, from the number of CBGs, that is received in error, and transmits a CBG code-point, from the CBG code-points, corresponding to the CBG received in error. In various embodiments, the UE receives a DCI format scheduling a second transport block on a PDSCH. The DCI format includes a CBG code point, from the CBG code-points, indicating the CBGs included in the second transport block (e.g., second transmission).

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive a first wake-up signal (WUS), and
receive first configuration information in a first channel associated with the first WUS, after a time T1 from the first WUS; and
a processor operably coupled to the transceiver, the processor configured to apply the first configuration information after a time T2 from reception of the first channel.

2. The UE of claim 1, wherein:
the transceiver is further configured to:
transmit a second WUS, and
receive second configuration information in a second channel associated with the second WUS, after a time T3 from the second WUS; and
the processor is further configured to apply the second configuration information after a time T4 from reception of the second channel.

3. The UE of claim 1, wherein:
the transceiver is further configured to receive multiple configurations,
each configuration from the multiple configurations is associated with an index, and
the first configuration information is an index identifying one of the multiple configurations.

4. The UE of claim 1, wherein:
the first configuration information provides a type of a time-unit or a frequency-unit, and
the type is one of: downlink, uplink, idle, or sensing.

5. The UE of claim 1, wherein:
the transceiver is further configured to receive third configuration information for code-block group (CBG) code-points,
the third configuration information associates a CBG code-point with one or more CBGs,
the transceiver is further configured to receive a first transport block including a number of CBGs,
the processor is further configured to identify a CBG, from the number of CBGs, that is received in error,
when there is no CBG code-point corresponding to the CBG received in error, the transceiver is further configured to transmit a code-point X from the CBG code-points, and
the code-point X corresponds to all of the number of CBGs.

6. The UE of claim 1, wherein:
the transceiver is further configured to receive third configuration information for code-block group (CBG) code-points,
the third configuration information associates a CBG code-point with one or more CBGs,
the transceiver is further configured to receive a first transport block including a number of CBGs,
the processor is further configured to identify a CBG, from the number of CBGs, that is received in error, and
the transceiver is further configured to transmit a CBG code-point, from the CBG code-points, corresponding to the CBG received in error.

7. The UE of claim 6, wherein:
the transceiver is further configured to receive a downlink control information (DCI) format scheduling a second transport block on a physical downlink shared channel (PDSCH), and
the DCI format includes a CBG code point, from the CBG code-points, indicating the CBGs included in the second transport block.

8. A base station (BS), comprising:
a transceiver configured to:
transmit a first wake-up signal (WUS), and
transmit first configuration information in a first channel associated with the first WUS, after a time T1 from the first WUS; and
a processor operably coupled to the transceiver, the processor configured to apply the first configuration information after a time T2 from reception of the first channel.

9. The BS of claim 8, wherein:
the transceiver is further configured to:
receive a second WUS, and
transmit second configuration information in a second channel associated with the second WUS, after a time T3 from the second WUS; and
the processor is further configured to apply the second configuration information after a time T4 from reception of the second channel.

10. The BS of claim 8, wherein:
the transceiver is further configured to transmit multiple configurations,
each configuration from the multiple configurations is associated with an index, and
the first configuration information is an index identifying one of the multiple configurations.

11. The BS of claim 8, wherein:
the first configuration information provides a type of a time-unit or a frequency-unit, and
the type is one of: downlink, uplink, idle, or sensing.

12. The BS of claim 8, wherein:
the transceiver is further configured to transmit third configuration information for code-block group (CBG) code-points,
the third configuration information associates a CBG code-point with one or more CBGs,
the transceiver is further configured to transmit a first transport block including a number of CBGs,
when there is no CBG code-point corresponding to the CBG received in error, the transceiver is further configured to receive a code-point X from the CBG code-points, and
the code-point X corresponds to all of the number of CBGs.

13. The BS of claim 8, wherein:
the transceiver is further configured to transmit third configuration information for code-block group (CBG) code-points,
the third configuration information associates a CBG code-point with one or more CBGs,
the transceiver is further configured to transmit a first transport block including a number of CBGs, and
the transceiver is further configured to receive a CBG code-point, from the CBG code-points, corresponding to the CBG in error.

14. The BS of claim 13, wherein:
the transceiver is further configured to transmit a downlink control information (DCI) format scheduling a second transport block on a physical downlink shared channel (PDSCH), and
the DCI format includes a CBG code point, from the CBG code-points, indicating the CBGs included in the second transport block.

15. A method of operating a user equipment (UE), the method comprising:
receiving a first wake-up signal (WUS);
receiving first configuration information in a first channel associated with the first WUS, after a time T1 from the first WUS; and
applying the first configuration information after a time T2 from reception of the first channel.

16. The method of claim 15, further comprising:
transmitting a second WUS;
receiving second configuration information in a second channel associated with the second WUS, after a time T3 from the second WUS; and
applying the second configuration information after a time T4 from reception of the second channel.

17. The method of claim 15, further comprising:
receiving multiple configurations,
wherein each configuration from the multiple configurations is associated with an index, and
wherein the first configuration information is an index identifying one of the multiple configurations.

18. The method of claim 15, further comprising:
receiving third configuration information for code-block group (CBG) code-points, wherein the third configuration information associates a CBG code-point with one or more CBGs;
receiving a first transport block including a number of CBGs;
identifying CBG, from the number of CBGs, that is received in error; and
when there is no CBG code-point corresponding to the CBG received in error, transmitting a code-point X from the CBG code-points, wherein the code-point X corresponds to all of the number of CBGs.

19. The method of claim 15, further comprising:
receiving third configuration information for code-block group (CBG) code-points, wherein the third configuration information associates a CBG code-point with one or more CBGs;
receiving a first transport block including a number of CBGs;
identifying CBG, from the number of CBGs, that is received in error; and
transmitting a CBG code-point, from the CBG code-points, corresponding to the CBG received in error.

20. The method of claim 19, further comprising:
receiving a downlink control information (DCI) format scheduling a second transport block on a physical downlink shared channel (PDSCH),
wherein the DCI format includes a CBG code point, from the CBG code-points, indicating the CBGs included in the second transport block.
